(19) United States
(12) Patent Application Publication
(10) Pub. No.: US 2016/0342911 A1
(43) Pub. Date: Nov. 24, 2016

(54) METHOD AND SYSTEM FOR EFFECTING CUSTOMER VALUE BASED CUSTOMER INTERACTION MANAGEMENT

(71) Applicant: 24/7 Customer, Inc., Campbell, CA (US)

(72) Inventors: Pallipuram V. KANNAN, Saratoga, CA (US); Bhupinder SINGH, Bangalore (IN); R. Mathangi SRI, Bangalore (IN)

(21) Appl. No.: 15/154,882

(22) Filed: May 13, 2016

Related U.S. Application Data
(60) Provisional application No. 62/163,596, filed on May 19, 2015.

(51) Int. Cl. G06Q 10/06; G06Q 30/00

(52) U.S. Cl. CPC G06Q 10/0631; G06Q 30/01

(57) ABSTRACT

A computer-implemented method and a system for effecting customer value based customer interaction management include determining an initial estimate of a customer value for a customer of an enterprise. The initial estimate of the customer value is determined using interaction data associated with past interactions of the customer with the enterprise on one or more interaction channels. At least one persona type is identified corresponding to the customer and each persona type from among the at least one persona type is associated with a respective pre-determined correction factor. The initial estimate of the customer value is corrected using the pre-determined correction factor corresponding to the each persona type to generate a corrected estimate of the customer value. One or more recommendations are generated based on the corrected estimate of the customer value with an intention of achieving, at least in part, one or more predefined objectives of the enterprise.

### CROSS REFERENCE TO RELATED APPLICATIONS

This application claims priority to U.S. provisional patent application Ser. No. 62/163,596, filed May 19, 2015, which is incorporated herein in its entirety by this reference thereto.

### TECHNICAL FIELD

The invention generally relates to customer interaction management and more particularly to a method and system for effecting customer value based customer interaction management.

### BACKGROUND

Assessing value of a customer relationship, or in general a customer, may be performed using various known techniques. For example, Customer Lifetime Value or CLV is a well-known concept used in a number of fields for representing a monetary value of a customer relationship, or, more specifically CLV is a prediction of all value a business will derive from their entire relationship with a customer.

Enterprises typically use such customer value assessment mechanisms to identify a right segment of customers to treat differentially to maximize their revenue, to design appropriate advertisement campaigns, to model chum rates of the customers, and the like.

Conventional approaches generally model customer value as a function of monetary values associated with past transactions, frequency of transactions, recency of transactions, and the like. Such approaches do not take into account many behavioral aspects associated with the customers. For example, if two customers have a similar past record of monetary transactions and interactions, then a customer who has a greater tendency to return products or seek discounts should, in effect, have a lower customer value. In another example scenario, if two customers have a similar past record of monetary transactions and interactions, then a customer who has a greater tendency to make impulsive purchases (and hence, more likely to be influenced by promotional offers or directed advertisements) should, in effect, have a higher customer value. However, conventional approaches preclude such key behavioral insights while arriving at a customer value.

Assessing customer values while ignoring their individual behavioral attributes may lead to an incorrect evaluation of customer segments to target and as such may result in ineffective management of customer relationships, in poor customer experience, and the like. In some cases, the customers may abandon an interaction on account of incorrect targeting of promotional offers or advertisements, perhaps never to return.

Accordingly, it would be advantageous to take customer behavioral attributes into account while assessing customer values so as to effect improved customer interaction management.

### SUMMARY

In an embodiment of the invention, a computer-implemented method for effecting customer value based customer interaction management is disclosed. The method determines, by a processor, an initial estimate of a customer value for a customer of an enterprise. The initial estimate of the customer value is determined using interaction data associated with past interactions of the customer with the enterprise on one or more interaction channels. The method identifies, by the processor, at least one persona type corresponding to the customer from among a plurality of persona types. Each persona type from among the at least one persona type is associated with a respective pre-determined correction factor. The method corrects, by the processor, the initial estimate of the customer value using the pre-determined correction factor corresponding to the each persona type to generate a corrected estimate of the customer value. Further, the method generates, by the processor, one or more recommendations corresponding to the customer based on the corrected estimate of the customer value. The one or more recommendations are generated with an intention of achieving, at least in part, one or more predefined objectives of the enterprise.

In another embodiment of the invention, a system for effecting customer value based customer interaction management includes at least one processor and a memory. The memory stores machine executable instructions therein that, when executed by the at least one processor, cause the system to determine an initial estimate of a customer value for a customer of an enterprise. The initial estimate of the customer value is determined using interaction data associated with past interactions of the customer with the enterprise on one or more interaction channels. The system identifies at least one persona type corresponding to the customer from among a plurality of persona types. Each persona type from among the at least one persona type is associated with a respective pre-determined correction factor. The system corrects the initial estimate of the customer value using the pre-determined correction factor corresponding to the each persona type to generate a corrected estimate of the customer value. Further, the system generates one or more recommendations corresponding to the customer based on the corrected estimate of the customer value. The one or more recommendations are generated with an intention of achieving, at least in part, one or more predefined objectives of the enterprise.

In another embodiment of the invention, a computer-implemented method for effecting customer value based customer interaction management is disclosed. The method determines, by a processor, a customer lifetime value (CLV) estimate for a customer of an enterprise. The CLV estimate is determined using interaction data associated with past interactions of the customer with the enterprise on one or more interaction channels. The method identifies, by the processor, an aggregate persona type corresponding to the customer from among a plurality of persona types. The aggregate persona type is identified using the interaction data associated with the past interactions of the customer. The aggregate persona type is associated with a first correction factor. The method identifies, by the processor, an instantaneous persona type corresponding to the customer from among the plurality of persona types. The instantaneous persona type is identified based on a current activity of the customer on an interaction channel associated with the enterprise. The instantaneous persona type is associated with a second correction factor. The method corrects, by the processor, the CLV estimate of the customer using the first correction factor and the second correction factor to generate a corrected CLV estimate. The method generates, by the processor, one or more recommendations corresponding to the customer based on the corrected CLV estimate. The one or more recommendations are generated with an intention of achieving, at least in part, one or more predefined objectives of the enterprise.

In yet another embodiment of the invention, a computer-implemented method for effecting customer value based customer interaction management is disclosed. The method determines, by a processor, an estimate of a customer value for a customer of an enterprise based on a current activity of the customer on at least one interaction channel from among a plurality of interaction channels associated with the enterprise. The method identifies, by the processor, a target treatment for the customer using interaction data associated with past interactions of the customer with the enterprise on one or more interaction channels from among the plurality of interaction channels. The target treatment is identified upon determining the estimate of the customer value to be greater than a pre-determined threshold value. The method facilitates, by the processor, a provisioning of at least one of a personalized treatment and a preferential treatment to the customer during the current activity of the customer on the at least one interaction channel based on the identified target treatment.

### BRIEF DESCRIPTION OF THE FIGURES

FIG. 1 is a schematic diagram showing an illustrative environment in accordance with an example scenario;

FIG. 2 is a block diagram of a system configured to effect customer value based customer interaction management, in accordance with an embodiment of the invention;

FIG. 3 is a schematic diagram showing a customer active on a web interaction channel of the enterprise for illustrating identification of the instantaneous persona type of the customer, in accordance with an embodiment of the invention;

FIG. 4 shows a simplified representation of a scenario involving distribution of promotional material to customers of an enterprise based on corrected estimates of respective customer values, in accordance with an embodiment of the invention;

FIG. 5 is a simplified representation showing agents assisting customers of an enterprise based on recommendations generated by the system of FIG. 2, in accordance with an embodiment of the invention;

FIG. 6 is a flow diagram of an example method for effecting customer value based customer interaction management, in accordance with an embodiment of the invention;

FIG. 7 is a flow diagram of an example method for effecting customer value based customer interaction management, in accordance with another embodiment of the invention;

FIG. 8 is a flow diagram of an example method for effecting customer value based customer interaction management, in accordance with yet another embodiment of the invention; and

FIG. 9 is a flow diagram of an example method for effecting customer value based customer interaction management, in accordance with yet another embodiment of the invention.

### DETAILED DESCRIPTION

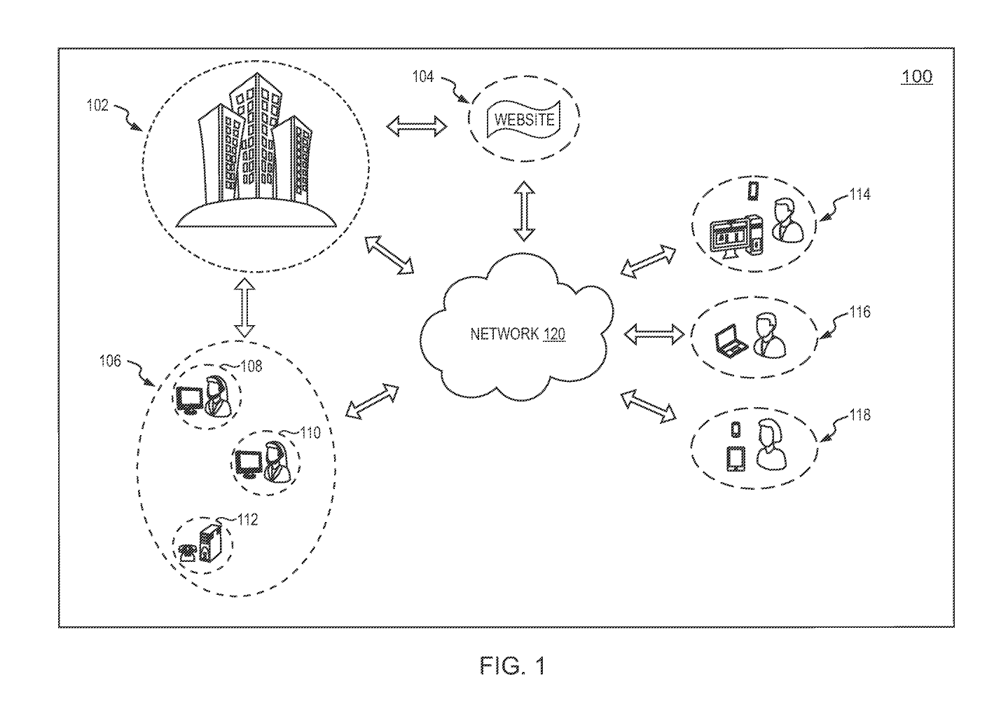

FIG. 1 is a schematic diagram showing an illustrative environment 100 in accordance with an example scenario. The environment 100 depicts an example enterprise 102. Though the enterprise 102 is exemplarily depicted to be a firm, it is understood that the enterprise 102 may be a corporation, an institution, a small/medium sized company or even a brick and mortar entity. For example, the enterprise 102 may be a banking enterprise, an educational institution, a financial trading enterprise, an aviation company, a retail outlet or any such public or private sector enterprise. It is understood that many users may use products, services and/or information offered by the enterprise 102. The existing and/or potential users of the enterprise offerings are referred to herein as customers of the enterprise 102. It is also noted that the customers of the enterprise 102 may not be limited to individuals. Indeed, in many example scenarios, groups of individuals or other enterprise entities may also be customers of the enterprise 102.

The enterprises, such as the enterprise 102, offer multiple interaction channels to customers for facilitating customer interactions. For example, enterprises provide a website or a web portal, i.e. a web channel, to enable the customers to locate products/services of interest, to receive information about the products/services, to make payments, to lodge complaints, and the like. In another illustrative example, enterprises offer virtual agents to interact with the customers and enable self-service. In yet another illustrative example, the enterprises offer dedicated customer sales and service representatives, such as live agents, to interact with the customers by engaging in voice conversations, i.e. use a speech interaction channel, and/or chat conversations, i.e. use a chat interaction channel. Similarly, the enterprises offer other interaction channels such as an email channel, a social media channel, a native application channel and the like.

In the environment 100, the enterprise 102 is depicted to be associated with a website 104 and a dedicated customer support facility 106 including human resources and machine-based resources for facilitating customer interactions. The customer support facility 106 is exemplarily depicted to include two live agents 108 and 110 (who provide customers with voice-based assistance and chat-based/online assistance, respectively) and an automated voice response system, such as IVR system 112. It is understood that the customer support facility 106 may also include automated chat agents such as chat bots, and other web or digital self-assist mechanisms. Moreover, it is noted that customer support facility 106 is depicted to include only two live agents 108 and 110 and the IVR system 112 for illustration purposes and it is understood that the customer support facility 106 may include fewer or more number of resources than those depicted in FIG. 1.

The environment 100 further depicts a plurality of customers, such as a customer 114, a customer 116 and a customer 118. As explained above, the term ‘customers’ as used herein includes both existing customers as well as potential customers of information, products and services offered by the enterprise 102. Further, it is understood that three customers are depicted herein for example purposes and that the enterprise 102 may be associated with many such customers. In some example scenarios, the customers 114, 116 and 118 may browse the website 104 and/or interact with the resources deployed at the customer support facility 106 over a network 120 using their respective electronic devices. Examples of such electronic devices may include mobile phones, smartphones, laptops, personal computers, tablet computers, personal digital assistants, smart watches, web-enabled wearable devices and the like. Examples of the network 120 may include wired networks, wireless networks or a combination thereof. Examples of wired networks may include the Ethernet, local area networks (LANs), fiber-optic cable networks and the like. Examples of wireless networks may include cellular networks like GSM/3G/4G/CDMA based networks, wireless LANs, Bluetooth or Zigbee networks and the like. An example of a combination of wired and wireless networks may include the Internet.

Typically, the customers of the enterprise 102 may initiate interaction with the enterprise 102 for a variety of purposes, such as for example, to enquire about billing or payment, to configure a product or troubleshoot an issue related to a product, to enquire about upgrades, to enquire about shipping of a product, to provide feedback, to register a complaint, to follow up about a previous query and the like. As explained above, customer interactions with the enterprise 102 are carried out over multiple interaction channels. In some cases, the interactions may be initiated by the enterprise 102, itself. For example, the enterprise 102 may send targeted emails or SMS to potential/existing customers informing them of a new product launch or an inauguration of a new store location. In other example scenario, the enterprise 102 may send out catalogues or brochures displaying range of current product or services to the customers. Accordingly, it is understood that the customers and the enterprise 102 may interact with each other using various channels and/or using various devices.

Most enterprises, typically, seek to estimate a value of each customer in order to identify a right segment of customers to treat differentially in order to maximize their revenue, to design appropriate advertisement campaigns, to model churn rates of the customers, and the like. For example, an enterprise 102, may determine a Customer Lifetime Value or CLV for each of its customer to arrive at a monetary value the enterprise will derive from their entire relationship with the respective customer. In an illustrative example, if the customer has a high CLV, then the enterprise 102 may display widgets or pop-up windows offering promotional offers or discounts to the customer for a product that the customer is currently viewing on an enterprise website. In another illustrative example, the customer may be offered agent assistance through chat or voice channel in order to enable the customer to make a purchase or to improve an online experience of the customer.

Conventional approaches generally model customer value as a function of a monetary value of past transactions, a frequency of transactions, a recency of transactions and the like. The customer values are then used to segment customers and behavioral traits are then assigned to the customer segment as a whole. In some example scenarios, the customers are profiled based on age, gender, socio-economic status, profession and the like. However, even though customers within a shared user profile may share common attributes, they may exhibit markedly different behavior as consumers of products/services. For example, one middle-aged male may prefer shopping online for convenience purposes, whereas another middle-aged male may prefer to purchase goods/services in physical stores on account of a personal preference to visually see and touch/feel the product. Similarly, an individual may prefer to perform transactions over a web channel, whereas another individual may prefer to speak with an agent, i.e. use the speech channel, prior to making the purchase.

Such approaches do not take into account many individual behavioral aspects associated with the customers. For example, a customer who is known to chronically complain about a product or a service should have a lower customer value than another customer who has a similar past record of monetary transactions and interactions, since the customer may have a higher tendency to return a product, or make cancellations. Similarly, customers who are ‘impulsive buyers’ (indicative of impulsive buying behavior without prior intent of making a purchase) may have higher customer value, compared to ‘researchers’ who would carefully review the product details and product pricing against the competition, given a similar transaction/interaction background. The traditional models for assessing customer value do not take such behavioral characteristics of customers into account and as such, the conventional customer value evaluation mechanisms need improvement.

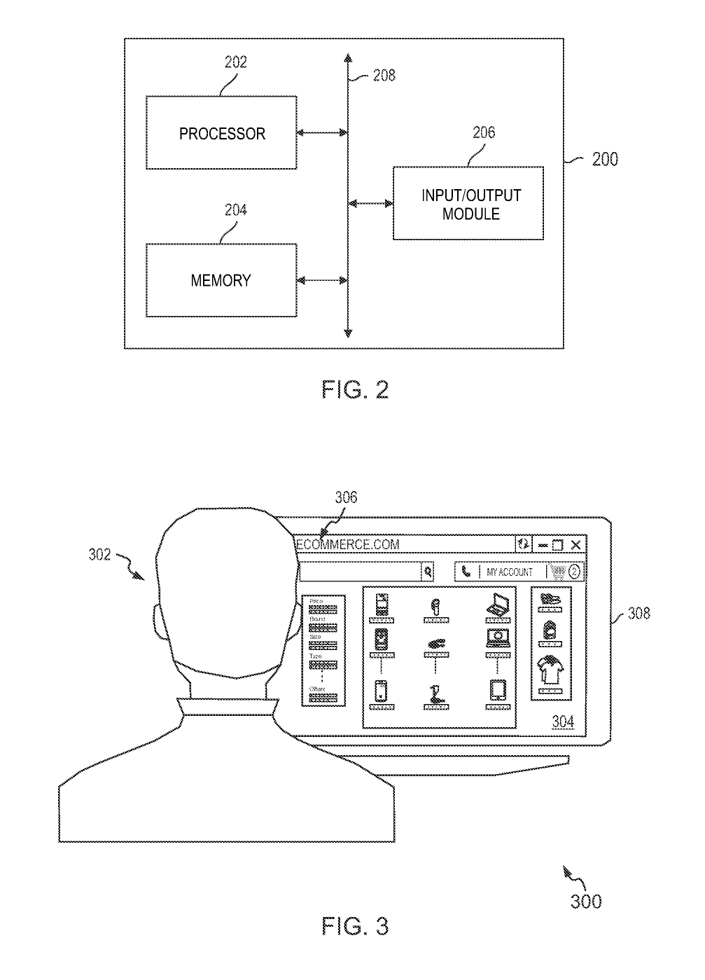

Various embodiments of the invention provide methods and systems that are capable of overcoming these and other obstacles and providing additional benefits. More specifically, methods and systems disclosed herein suggest incorporating a customer's persona type or behavioral characteristics into account in order to reflect a correct value of the customer, which in turn may be used to effect improved customer interaction management. A system for effecting customer value based customer interaction management is explained with reference to FIG. 2.

FIG. 2 is a block diagram of a system 200 configured to effect customer value based customer interaction management, in accordance with an embodiment of the invention. The term ‘customer’ as used herein refers to either an existing user or a potential user of products, services or information offered by an enterprise. Moreover, the term ‘customer’ of the enterprise may include individuals, groups of individuals, other organizational entities etc. As explained with reference to FIG. 1, the term ‘enterprise’ may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise. The term ‘customer interaction management’ as used herein implies managing interactions with customers in an online or an offline manner, such that, an enterprise objective of increasing sales or improving an overall customer's experience of interacting with the enterprise is improved. For example, managing interaction for an online customer may involve customizing a website experience or offering agent help to assist the customer with his or her respective needs. In another illustrative example, managing customer interaction when the customer is offline may involve sending customers SMS alerts of important events such as bill payment that is due or sending promotional offers or discount coupons for products that the customer may have previously showed interest in.

The system 200 includes at least one processor, such as a processor 202 and a memory 204. It is noted that although the system 200 is depicted to include only one processor, the system 200 may include more number of processors therein. In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The system 200 also includes an input/output module 206 (hereinafter referred to as ‘I/O module 206’) for providing an output and/or receiving an input. The I/O module 206 is configured to be in communication with the processor 202 and the memory 204. Examples of the I/O module 206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

In an embodiment, the I/O module 206 may be configured to provide a user interface (UI) configured to enable enterprises to utilize the system 200 for effecting customer value based customer interaction management. Furthermore, the I/O module 206 may be integrated with a monitoring mechanism configured to provide the enterprises with real-time recommendations/updates/alerts (for example, email notifications, SMS alerts, etc.) of changes to be made to the system 200 for effecting customer value based customer interaction management.

The I/O module 206 may further be configured to effect display of various user interfaces on remote devices. The remote devices may be customer-owned or customer-associated devices. In at least one example embodiment, the I/O module 206 may be configured to be in communication with an interaction client including device application programming interfaces (APIs) capable of pushing content such as chat console UIs on customer devices for facilitating respective online interactions between customers and agents of the enterprise.

In an embodiment, various components of the system 200, such as the processor 202, the memory 204 and the I/O module 206 are configured to communicate with each other via or through a centralized circuit system 208. The centralized circuit system 208 may be various devices configured to, among other things, provide or enable communication between the components (202-206) of the system 200. In certain embodiments, the centralized circuit system 208 may be a central printed circuit board (PCB) such as a motherboard, a main board, a system board, or a logic board. The centralized circuit system 208 may also, or alternatively, include other printed circuit assemblies (PCAs) or communication channel media.

It is understood that the system 200 as illustrated and hereinafter described is merely illustrative of a system that could benefit from embodiments of the invention and, therefore, should not be taken to limit the scope of the invention. It is noted that the system 200 may include fewer or more components than those depicted in FIG. 2. In an embodiment, the system 200 may be implemented as a platform including a mix of existing open systems, proprietary systems and third party systems. In another embodiment, the system 200 may be implemented completely as a platform including a set of software layers on top of existing hardware systems. In an embodiment, one or more components of the system 200 may be deployed in a web server. In another embodiment, the system 200 may be a standalone component in a remote machine connected to a communication network (such as the network 120 explained with reference to FIG. 1) and capable of executing a set of instructions (sequential and/or otherwise) so as to effect customer value based customer interaction management. Moreover, the system 200 may be implemented as a centralized system, or, alternatively, the various components of the system 200 may be deployed in a distributed manner while being operatively coupled to each other. In an embodiment, one or more functionalities of the system 200 may also be embodied as a client within devices, such as customers' devices. In another embodiment, the system 200 may be a central system that is shared by or accessible to each of such devices.

In an embodiment, the I/O module 206 is configured to receive interaction data for a plurality of customers of an enterprise, such as the enterprise 102 explained with reference to FIG. 1. The I/O module 206 may receive the interaction data from a plurality of interaction channels. The plurality of interaction channels may include channels such as, but not limited to, a voice channel, a chat channel, a web channel, an IVR channel, a social channel, a native channel (i.e. a device application channel), a branch channel and the like. The term ‘interaction data’ as used herein refers to any type of data (textual or otherwise) associated with customer interaction on an interaction channel. For example, a web interaction of a customer may imply a customer browsing a website of an enterprise. In such a scenario, the interaction data captured may include information such as web pages visited, time spent on each web page, menu options accessed, drop-down options selected or clicked, mouse movements, hypertext mark-up language (HTML) links those which are clicked and those which are not clicked, focus events (for example, events during which the customer has focused on a link/webpage for a more than a pre-determined amount of time), non-focus events (for example, choices the customer did not make from information presented to the customer (for examples, products not selected) or non-viewed content derived from scroll history of the visitor), touch events (for example, events involving a touch gesture on a touch-sensitive device such as a tablet), non-touch events and the like. It is understood that an enterprise may use tags, such as HTML tags or JavaScript tags on the various elements of the website or, alternatively, the enterprise may open up a socket connection to capture information related to customer activity on its website. Further, it is understood that the I/O module 206 may be communicably associated with web servers hosting web pages of the enterprise website to receive such interaction data.

In another illustrative example, a chat interaction of a customer may imply a text-based bi-directional conversation between the customer and an agent (i.e. a customer service representative) of the enterprise. In such a scenario, conversational content related to the chat conversation including information such as a type of customer concern, which agent handled the chat interaction, customer concern resolution status, time involved in the chat interaction and the like, may be captured as interaction data. The I/O module 206 may be communicably associated with customer support facility, such as the customer support facility 106 explained with reference to FIG. 1, to receive interaction data related to customer voice conversations and chat conversations with various agents of the enterprise.

Furthermore, in at least one example embodiment, the I/O module 206 may also be communicably associated with data gathering servers, to receive non-interaction data related to the customers. For example, the data gathering servers may collate other customer related data such as name, mailing address, email ID, phone number, login IDs, IP address and the like. Such non-interaction data may be collated from a plurality of interaction channels and/or a plurality of devices utilized by the customers. To that effect, the data gathering servers may be in operative communication with various customer touch points, such as electronic devices associated with the customers, websites visited by the customers, customer support representatives (for example, voice-agents, chat-agents, IVR systems, in-store agents, and the like) engaged by the customers and the like. In an embodiment, the processor 202 is configured to correlate non-interaction data (received from the data gathering servers) with interaction data across interaction channels for each customer and store the information in the memory 204. The system 200, as will be explained in detail later, is configured to compute customer values for each customer using respective stored data and thereafter effect management of on-going and subsequent interactions with those customers based on their respective customer values. The effecting of customer interaction management using customer values by the system 200 is explained hereinafter with reference to one customer. It is understood that the system 200 is configured to manage customer interactions for several other customers of the enterprise in a similar manner.

In at least one example embodiment, the processor 202 is configured to, with the content of the memory 204, cause the system 200 to determine an initial estimate of a customer value for a customer of an enterprise. The term ‘customer value’ as used hereinafter refers to a present or a future value of a customer relationship for an enterprise. In an illustrative example, the customer value may be expressed in monetary terms. For example, a customer value for a customer may be 500 US dollars, implying that the customer is capable of providing business worth 500 US dollars over a predefined time duration, for example, one year, a lifetime, etc. In at least one embodiment, the predefined time duration may be calculated based on any one of a duration of customer loyalty since initial acquisition to a present point in time, a duration of customer loyalty since initial acquisition to a specified time in future, a duration of customer loyalty since initial acquisition to a forecasted churn in future, etc.

In an embodiment, the initial estimate of the customer value is determined using interaction data associated with past interactions of the customer with the enterprise on one or more interaction channels. More specifically, interaction data associated with all previous interactions of the customer with the enterprise (for example, previous chat or voice call conversations with agents, historic visits to the website, past interactions with enterprise self-help systems, such as an IVR etc.) may be used to determine the initial estimate of the customer value.

In an illustrative example, the system 200 is caused to compute a Customer Lifetime Value (CLV) estimate. The system 200 may further be caused to treat the computed CLV estimate as the initial estimate of the customer value for the customer. It is understood the CLV estimate may be determined using various known techniques. For example, the CLV estimate may be determined using a Recency-Frequency-Monetary Value (RFM) approach, which models the customer value as a function of how recently the customer interacted with the enterprise, a frequency of customer interactions and monetary values of customer transactions associated with the customer interactions. It is noted that the components related to the recency and frequency of interactions in the RFM approach or any other model/approach used for computing the CLV estimate, may take into account customer interactions across one or more of a plurality of interaction channels. For example, a customer may have contacted an enterprise five times over a chat channel and three times over a voice channel, in the past week. In such a scenario, frequency of contacts for the customer is computed across the chat channel and the voice channel or any other channel through which the customer may have interacted in the past week. Accordingly, the CLV estimate of such a customer is higher when compared with another customer's CLV estimate who has contacted only once over a social channel and twice over the chat channel in the same week, assuming that other parameters for the two customers are alike.

In an example scenario, a monetary value may be determined corresponding to each interaction channel that the customer has used for interacting with the enterprise and the CLV estimate may be computed by averaging or weighted averaging of the monetary values corresponding to the various interaction channels. For example, a monetary value corresponding to the web channel may be determined based on cumulative revenue or margin from all historic purchases, as well as aggregated weighted monetary value of all products viewed by the customer, clicked by the customer, hovered over by the customer, touched by the customer and the like. The monetary value may also be derived or adjusted from parameters such as the time spent on a view, time spent on pages, time spent on site, etc. In another illustrative example, on a chat channel, monetary value may be extracted based on identifying the products mentioned in a chat conversation through named entity recognition, or collaboratively tagged by users on the chat or voice platform. An overall monetary value across various interaction channels for each customer may then be determined by the system 200 using suitable classifiers, models or collaborative tags to arrive at the initial estimate of a customer value. In an illustrative example, the CLV estimate (i.e. customer value) for a customer may be 950 US dollars based on the RFM approach. It is noted that for another customer with different variables related to recency of interactions, frequency of interactions and monetary values associated with those interactions, the CLV estimate may be different, such as for example, 800 US dollars. It is understood that such CLV estimates enable the enterprise to segment the customers into different categories and cater to them based on their perceived customer values.

It is also noted that the customer value may be estimated in other forms and may not be limited to a CLV estimate. Moreover, the CLV estimate may be determined using any one of several models such as those based on stochastic modeling, Markov models, Markov decision process (MDP), policy iteration algorithms for infinite horizon problems, value iteration algorithms for finite horizon problems, survival models, retention or churn models and the like, and may not be limited to the RFM approach. Such approaches model CLV as a function of recency, frequency, monetary value, discount rate, churn/retention rate, acquisition rate, retention costs, acquisition costs, revenue, advertising or campaign cost, cost of serving the customers, state transition probability matrix, and the like.

In at least one example embodiment, the processor 202 is configured to, with the content of the memory 204, cause the system 200 to identify at least one persona type corresponding to the customer from among a plurality of persona types. The term ‘persona type’ or ‘persona’ as used interchangeably hereinafter refers to characteristics reflecting behavioral patterns, goals, motives and personal values of the customer. It is noted that ‘personas’ as used herein is distinct from the concept of user profiles, that are classically used in various kinds of analytics, where similar groups of customers are identified based on certain commonality in their attributes, which may not necessarily reflect behavioral similarity, or similarity in goals and motives. An example of a customer persona type may be a ‘convenience customer’ that corresponds to a group of customers characterized by the behavioral trait that they are focused and are looking for expeditious delivery of service. In an embodiment, a behavioral trait as referred to herein corresponds to a biological, sociological or a psychological characteristic. An example of a psychological characteristic may be a degree of decidedness associated with a customer while making a purchase. For example, some customers dither for a long time and check out various options multiple times before making a purchase, whereas some customers are more decided in their purchasing options. An example of a sociological characteristic may correspond to a likelihood measure of a customer to socialize a negative sentiment or an experience. For example, a customer upon having a bad experience with a product purchase may share his/her experience on social networks and/or complain bitterly on public forums, whereas another customer may choose to return the product and opt for another product, while precluding socializing his/her experience. An example of a biological characteristic may correspond to gender or even age-based inclination towards consumption of products/services or information. For example, a middle aged female may be more likely to purchase a facial product associated with ageing, whereas a middle aged man may be more likely to purchase a hair care related product. It is understood that examples of customer biological, sociological and psychological characteristics are provided herein for illustrative purposes and may not be considered limiting the scope of set of behavioral traits associated with a persona type and that each person type may include one or more such behavioral traits.

In an embodiment, in addition to storing the interaction data and the non-interaction data corresponding to the customers, the memory 204 is further configured to store a number of customer persona classification frameworks or taxonomies. The customer persona classification frameworks may be capable of facilitating a segregation of customers based on customer personas types.

In an embodiment, the processor 202 is configured to identify an aggregate persona type for the customer based on stored interaction data corresponding to the customer. To that effect, the processor 202 may be caused to choose/select an appropriate customer persona classification framework or taxonomy of persona types stored in the memory 204, based on factors such as predefined objectives of the enterprise and/or interaction channels associated with the customer interactions. Some non-limiting examples of the predefined objectives of the enterprise may include a sales objective, a service objective, an influence objective and the like. The sales objective may be indicative of a goal of increasing sales revenue of the enterprise. The service objective may be indicative of a motive of improving interaction experience of the customer, whereas the influence objective may be indicative of the motive of influencing a customer into making a purchase.

In an illustrative example, for a sales objective, the system 200 may be caused to select a customer persona classification framework including a set of persona types comprising: a researcher (for example, a customer who is likely to thoroughly investigate alternative products before making a purchase and read and compare product specifications), a loyal customer (for example, a customer with a strong affinity to a single or a selected few brands or products or services), a convenience customer (for example, a customer who is decided on what he/she wants and who is wanting to make a purchase quickly), a compulsive buyer (for example, a customer who has high propensity to buy products he/she might not have a need for and who is very likely to agree to an up-sell/cross-sell offer made by an agent), a deal seeker (for example, a customer who is seeking motivation to get the best available deal or discount for a product or purchase), a stump (for example, a customer who is convinced against making a purchase and is very unlikely to make a purchase regardless of the quality or timeliness of customer service), and the like. The frameworks may further include any other such taxonomies of persona types, including but not limited to Myer Briggs Types Indicator, digital personas, social character or influence, stage or decidedness of purchase, moods (for example, moods such as angry, depressed, surprised, sarcastic, unhappy, polite, etc.), propensity to commit fraud, digital proficiency, technical proficiency, linguistic proficiency, linguistic affinity, product or subscription plan attribute affinity, media content affinity (for example, affinity to content such as movies, sports, music, religious, etc.) and/or personas based on any other combination of personality traits.

The processor 202 may select an appropriate customer persona classification framework from among the plurality of customer persona classification frameworks based on a predefined objective of the enterprise. The processor 202 may thereafter use the plurality of persona types associated with the selected customer persona classification framework for identifying an aggregate persona type of the customer. In an embodiment, the aggregate persona type is predicted based on behavioral traits exhibited by the customer during various previous interactions with the enterprise. More specifically, the processor 202 is configured to analyze the interaction data to identify behavioral traits associated with the customer during various past interactions. The behavioral traits exhibited, mentioned, inferred or predicted based on past interaction history may be compared with sets of behavioral traits associated with the plurality of persona types in the selected customer persona classification framework to identify a presence of a match. The matching persona type may then be identified as the aggregate persona type of the customer. The aggregate persona type may be a single aggregate persona, or an aggregation of all historic personas over specified durations or time or over N previous interactions.

In an embodiment, in addition to identifying the aggregate persona type using the interaction data associated with the past interactions of the customer, the system 200 may be caused to identify an instantaneous persona type based on the current activity of the customer on the interaction channel. More specifically, for a customer, who is not currently engaged in an interaction with the enterprise (for example, not active on an enterprise website or interacting with an agent associated with the enterprise), then for such a customer, only an aggregate persona type may be identified. However, if the customer is currently active on an enterprise interaction channel, then an instantaneous persona type may also be identified for the customer. The identification of the instantaneous persona type for the customer is further explained below.

In at least one example embodiment, the system 200 may be caused to receive an input corresponding to a predefined business objective and an interaction channel associated with the current activity of the customer from a representative of the enterprise, such as for example, an agent of the enterprise. In at least one example embodiment, the system 200 may be caused to select a customer persona classification framework from among a plurality of customer persona classification frameworks stored in the memory 204 based on the input. As explained above, each customer persona classification framework is associated with one or more persona types. The system 200 may be caused to identify the instantaneous persona type corresponding to the customer based on the selected customer persona classification framework and the current activity of the customer on the interaction channel.

In an illustrative example, for an input corresponding to a service objective and an IVR channel, a customer classification framework with the following persona types may be selected: an enquirer (for example, a customer who asks a lot of questions), an intellectual (for example, a customer who showcases his knowledge or experience of using a particular product or service), an opportunist (for example, a customer who is complaining for a reason, such as a reason to gain discounts etc.), a meek customer (for example, a customer who is generally passive during communication and does not push his or her concern enough), an aggressive customer (for example, a customer who demands immediate resolution to a concern) etc. Accordingly, based on the on-going IVR interaction, the system 200 may be caused to deduce behavioral traits being exhibited and match those traits with attributes of the persona types in the selected customer classification framework to identify the instantaneous persona type. It is noted that the during the course of the interaction, a customer may exhibit various traits, for example, a customer can start the conversation with an enquiry (i.e. show behavioral traits of an enquirer) and when the agent responds with a response to the enquiry, then the customer may turn into an intellectual (for example, respond with a statement ‘I know the features of this product won't work as advertised as I have used this before’), and then turn into a stump (i.e. showcase a tendency to resist purchase). In such a scenario, the system 200 may be caused to employ a suitable classifier to converge the various attributes exhibited during the on-going interaction and identify an overall persona type for the current interaction as the instantaneous persona type for the customer. The usage of classifiers for converging several attributes is well known and is not explained herein. The determination of instantaneous persona type in an online scenario is explained with reference to FIG. 3.

FIG. 3 is a schematic diagram 300 showing a customer 302 active on a web interaction channel of the enterprise for illustrating identification of the instantaneous persona type of the customer 302, in accordance with an embodiment of the invention. More specifically, the schematic diagram 300 shows the customer 302 browsing a website 304 corresponding to an enterprise. The customer 302 is depicted to have accessed the website 304 using a web browser application 306 installed on a desktop computer 308. In the schematic diagram 300, the website 304 is exemplarily depicted as an e-commerce website. However, it is noted that the enterprise website may not be limited to an e-commerce website. In some example scenarios, the website 304 may correspond to any one of a social networking website, an educational content related portal, a news aggregator portal, a gaming or sports content related website, a banking website or any such website related to a corporate or governmental entity. It is understood that the website 304 may be hosted on a remote web server(s) associated with the enterprise and the web browser application 306 may be configured to retrieve one or more web pages associated with the website 304 over a communication network, such as the network 120 explained with reference to FIG. 1. It is also understood that the website 304 may attract a large number of existing and/or potential customers, such as the customer 302. Moreover, the customers may use web browser applications installed on a variety of electronic devices, such as mobile phones, smartphones, tablet computers, laptops, web enabled wearable devices such as smart watches and the like, to access the website 304 over the communication network.

As explained with reference to FIGS. 1 and 2, for sake of description, a customer's presence on an enterprise interaction channel, such as a website, is deemed as an interaction with the enterprise. Accordingly, a current session of the customer 302 accessing the website 304 and performing one or more activities on the website, such as browsing web pages of the website or viewing product images, etc, is referred to herein as a current interaction and the activities during the current interaction are referred to herein as current activity of the customer 302 on the website 304.

In at least one example embodiment, click-stream data associated with customer's journey on the website 304 may be captured for example by using tags or socket connections as explained with reference to FIG. 2. For example, the web pages visited, the products viewed on the web pages, the monetary value of the products clicked on or hovered over on the website 304 among various other such factors may be captured. The I/O module 206 is configured to receive the interaction data in substantially real-time and store the interaction data in the memory 204. In at least one example embodiment, the processor 202 is configured to identify an instantaneous persona type based on the interaction data associated with the current activity of the customer 302 on the website 304. More specifically, based on an input of a predefined objective and the interaction channel (i.e. the web channel), the processor 202 in conjunction with the memory 204, may cause the system 200 to select an appropriate customer persona classification framework including a set of persona types. The behavioral attributes exhibited or inferred from the current activity of the customer 302 on the website 304 may be compared with the attributes of the persona types in the customer persona classification framework for a match. The matching persona type may then be identified as the instantaneous persona type of the customer 302. For example, a maximum and minimum monetary value of products may be scraped from each web page that the customer 302 has visited during the current journey and an average monetary value may be computed. If the customer 302 has viewed or hovered over only high value products during the current interaction on the website 304, then a ‘high roller’ persona type may be identified as the instantaneous persona type for the customer 302. In another illustrative example, if the customer 302 during the current interaction is viewing products, which are slightly bolder than an average consumer taste, for example, an orange colored phone or an incandescent apparel, then an ‘adventurous’ persona type may be identified as the instantaneous persona type for the customer 302. In yet another illustrative example, if the customer 302 has viewed/hovered over only products that are offered on discounts, then the customer's instantaneous persona type may be identified as a ‘discount seeker’.

Though the identification of aggregate persona type and the instantaneous persona type for a customer is explained herein using a comparison of behavioral attributes exhibited, inferred or mentioned by the customer during their past and/or current interactions with known attributes associated with persona types, in at least some embodiments, the aggregate and/or the instantaneous persona type for customers may be determined from predictive models. For example, predictive models configured to factor in historical data over one or more interaction channels, explicit input from customers, entries in customer relationship management (CRM) databases, customer surveys, feedback from customer care representative (tagging by agent), social network analysis, customer review mining, etc. may be used by the system 200 to identify the aggregate and/or instantaneous persona type for each customer. The predictive models may be based on one or more algorithms such as algorithms based on support vector machines, one versus rest classifiers, decision trees, random forests, naïve Bayes, logistic regression, clustering (Kmeans or hierarchical clustering), text classification on customer reviews, social mining, speech or voice classification, image recognition algorithms on facial gestures or postures, body movements, handwriting recognition algorithms and the like.

Referring now to FIG. 2, in at least one example embodiment, the system 200 is caused to assign a correction factor (for example, a weight) to each persona type in the various customer persona classification frameworks. Accordingly, each persona type is associated with a respective pre-determined correction factor. The determination of a correction factor may be performed based on observed as well as experimental analysis of the effect of a particular persona type on a subsequent propensity of the customer to perform an action, such as for example, perform a purchase transaction during the current interaction. In at least one example embodiment, the correction factor may be a numerical value. For example, for a persona type ‘impulsive buyer’, who makes a purchase upon being showcased suitable promotional offers may be associated with a pre-determined correction factor of ‘1.2’. However, for a persona type ‘geek’, i.e. a customer who will thoroughly analyze the technical specifications of products and will make a purchase only after review of several competing products may be associated with a pre-determined correction factor of ‘0.7’. Accordingly, each of the aggregate and the instantaneous persona types may be associated with respective pre-determined correction factors.

In at least one example embodiment, the processor 202 is configured to, with the content of the memory 204, cause the system 200 to correct the initial estimate of the customer value using the pre-determined correction factor corresponding to the aggregate persona type and/or the instantaneous persona type to generate a corrected estimate of the customer value. As explained with reference to FIG. 2, an initial estimate of customer value, for example a CLV estimate, may be determined using known techniques, such as the RFM approach. Such an initial estimate of customer value may be corrected using the pre-determined correction factor(s) associated with identified persona type(s). For example, if only an aggregate persona type has been identified for a customer (i.e. an instantaneous customer persona type has not been identified as the customer is not currently active on any enterprise interaction channel), then the pre-determined correction factor associated with the aggregate persona type may be utilized to correct the initial estimate of the customer value to generate a corrected estimate of customer value (for example, a corrected CLV estimate). For example, if the aggregate persona type is associated with a pre-determined correction factor of ‘0.85’ and if the initial estimate of the customer value is 1000 US dollars, then the corrected estimate of the customer value may be determined, in one example embodiment, by simply multiplying the pre-determined correction factor with the initial estimate of the customer value, i.e. 0.85×1000, to generate the corrected estimate of customer value of 850 US dollars. In an illustrative example, if an instantaneous persona type is also identified for the customer and the instantaneous persona type is associated with a correction factor of ‘1.2’ then the final corrected estimate of the customer value may be determined, in one example embodiment, by simply multiplying the pre-determined correction factor with the corrected estimate of the customer value, i.e. 1.2×850, to generate the corrected estimate of customer value of 1020 US dollars. Such a correction of the customer value estimate enables the enterprise to take historic as well as current behavioral attributes of the customer into account while determining a target strategy for the customer.

In at least one example embodiment, the processor 202 is configured to, with the content of the memory 204, cause the system 200 to generate one or more recommendations corresponding to the customer based on the corrected estimate of the customer value. The one or more recommendations are generated with an intention of achieving, at least in part, one or more predefined objectives of the enterprise. For example, if a predefined objective of an enterprise is a sales objective, i.e. to increase sales revenue, then the one or more recommendations may be generated with an intention of achieving such an objective. In an illustrative example, based on the corrected estimate of the customer value, an example recommendation generated may be to offer a discount coupon to the customer as the corrected estimate of the customer value (for example, a higher value) indicates that the customer is more likely to buy when offered a discount. In the absence of such a persona type based correction to the customer value, all customers with similar customer values may be treated in a generic manner, thereby reducing an impact of such a customer targeting strategy.

In another illustrative example, a predefined objective may be a service objective, i.e. to improve a customer's interaction experience. In an example scenario, a metric for evaluating an improvement in customer's interaction experience in a service scenario is a cumulative lifetime experience (CLE) value. The CLE value may be computed from several sentiment, emotion or non-emotional interaction metrics (for example, average handle time (AHT), disconnection, voice referrals, etc.) associated with customer interactions on one or more channels, and from metrics for switching across interaction channels, as well as explicit feedback collected through customer surveys (for example, agent satisfaction surveys, net promoter score (NPS), etc.). It is noted that predictive models, such as machine learning models or statistical models, may be used in evaluating specific metrics for each interaction or the overall experience across several interactions. Accordingly, in a service scenario, for a customer who is currently active on an enterprise interaction channel, a recommendation to proactively offer chat assistance may be generated based on the corrected estimate of the customer value, which may indicate that the customer typically has a number of questions and would need assistance with the purchase.

In yet another illustrative example, a predefined objective may be an influence objective, i.e. to influence a potential customer into purchasing an enterprise offering. In an example scenario, where a product desired by the customer is out of stock, then based on the corrected estimate of the customer value, a recommendation may be generated to offer other similar products to the customer as the customer may have an ‘open persona type’ indicative of the fact that the customer may be open to exploring other options if a particular product is out of stock.

Some other examples of recommendations generated based on the corrected estimate of the customer value of a customer may include, but are not limited to, recommending up-sell/cross-sell products to the customer, suggesting products to up sell/cross-sell to an agent as a recommendation, offering a suggestion for a discount to the agent as a recommendation, recommending a style of conversation to the agent during an interaction, presenting a different set of productivity or visual widgets to agents with specific persona types on the agent interaction platform, presenting a different set of productivity or visual widgets to the customers with specific persona types on the customer interaction platform, suggesting proactive interaction, customizing the speed of interaction, customizing the speed of servicing information and the like.

In an example embodiment, based on the corrected estimate of the customer value for the customer, a recommendation suggesting routing the customer's interaction to the queue with the least waiting time or to the most suitable agent based on an agent persona type or a skill level associated with the agent, may also be generated by the system 200.

In some embodiments, the system 200 may also be caused to facilitate a provisioning, for example by using agents or directly through device APIs, of at least one of a personalized treatment and a preferential treatment to the customer based on the one or more recommendations. Some non-limiting examples of personalized treatment provisioned to the customer may include sending a self serve link to the customer, sharing a knowledge base article, providing resolution to a customer query over an appropriate interaction channel, escalating or suggesting escalation of customer service level, offering a discount to the customer, recommending products to the customer for up-sell/cross-sell, proactively offering interaction, customizing the speed of interaction, customizing the speed of servicing information, deflecting interaction to a different interaction channel historically preferred by the customer and the like. Some non-limiting examples of preferential treatment provisioned to the customer may include routing an interaction to an agent with the best matching persona type, routing the interaction to a queue with the least waiting time, providing immediate agent assistance, etc. In at least some embodiments, the personalized treatment and/or the preferential treatment may be provisioned to the customer based on interaction data associated with past interactions of the customer with the enterprise on one or more interaction channels. For example, if the customer has historically preferred voice call interaction, then the current chat conversation may be deflected to a voice call interaction to provide a personalized interaction experience to the customer. In another illustrative example, if the customer has historically abandoned an interaction when the customer has been made to wait to speak to an agent, then the customer may be provisioned preferential treatment, for example, in form of immediate agent assistance or by routing the interaction to a queue with the least waiting time.

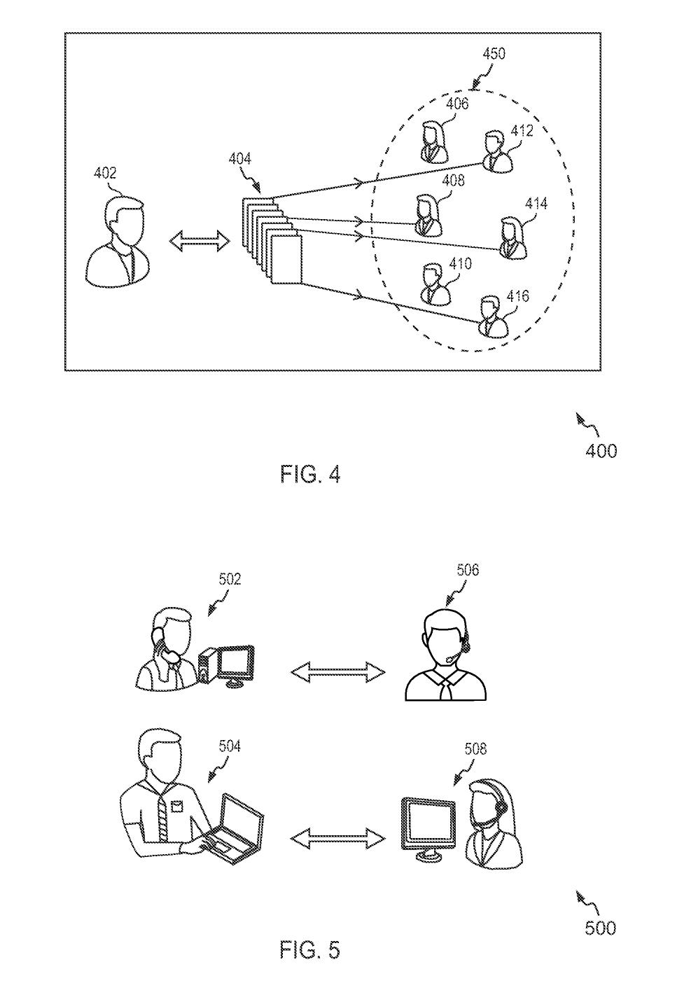

In an embodiment, the system 200 may perform the steps of determining the initial estimate of the customer value, identifying the at least one persona type and correcting the initial estimate of the customer value for each customer in a customer segment to generate a set of corrected estimates of the customer values corresponding to the plurality of customers in the customer segment. Further, based on the corrected estimates of the customer values directly, or based on factoring customer values as additional inputs in models for other response variables such as, purchase propensity, experience score, etc., the system 200 may be caused to suggest methods of intervention such as those related to stock replenishments (for example, how long the inventory will last may be predicted based on corrected estimate of customer values for a customer segment, and accordingly stocks may be replenished), staffing levels (for example, based on corrected estimate of customer values for various customer segments, staffing levels of customer support representatives may be determined), queue routing, program optimization, dynamic pricing, in-session targeting of customers (for example, providing campaigns during an on-going interaction in real-time), post-session retargeting of customers (for example, sending offline campaigns), omni-channel retargeting of customers, agent recommendation (for example, recommending agents most suitable to the customer persona type), service level escalation, etc. An example generation of recommendation based on corrected estimate of customer values for several customers is explained with reference to FIG. 4.

FIG. 4 shows a simplified representation 400 of a scenario involving distribution of promotional material to customers of an enterprise based on corrected estimates of respective customer values, in accordance with an embodiment of the invention. More specifically, an agent 402 of the enterprise may be entrusted with distributing a limited stock of promotional material 404 for a new campaign launched by the enterprise. The promotional material 404 may be a brochure, a new product catalog, a pamphlet showcasing new designs etc. In the conventional approach, the agent 402 may be have selected customers, such as customers 406, 408, 410 and several other customers from among a plurality of customers 450 as their respective customer values were higher than the remaining customers. More specifically, in absence of persona type based correction of customer values; the highest valued customers may be the primary targets of such campaign. However, many of such highest valued customers may not be behaviorally inclined to make purchases based on promotional material, such as the promotional material 404.

As explained with reference to FIG. 2, the system 200 may be caused to first determine an initial estimate of a customer value (for example, a CLV estimate). Thereafter, based on a predefined objective (for example, a sales objective), the system 200 may be caused to select an appropriate customer persona classification framework including several customer persona types. The system 200 may then identify aggregate persona type for each customer based on a match of behavioral attributes exhibited by the customer during past interactions and the behavioral attributes of the persona types in the selected customer classification framework, or based on predictive models as explained with reference to FIG. 2. The identified aggregate persona type is associated with a pre-determined correction factor, which may then be used to correct the estimate of the customer value for each customer. In an illustrative example, customers who are associated with aggregate persona type of ‘impulsive buyers’ may be associated with higher customer values subsequent to correction as they are more likely to purchase from the promotional material 404. Similarly, customers associated with aggregate persona type of ‘convenience customer’ may be associated with higher customer values subsequent to correction as they are more likely to purchase from the promotional material 404. On the other hand, the customers associated with aggregate persona type of ‘geeks’ or ‘researchers’, who are likely to compare several competing products prior to making a purchase may be associated with lower customer values subsequent to correction as they are more likely to be not influenced by the promotional material 404. In an example scenario, the customers 408, 412, 414 and 416 may have higher customer values amongst customers of the enterprise, subsequent to correction of the customer values and accordingly the system 200 may be caused to generate a recommendation for the agent 402 to provision the promotional material 404 to the customers 408, 412, 414 and 416. In some example scenarios, the system 200 may further be caused to generate recommendations related to the most suitable interaction channel (for example, email, physical post etc.) and/or the most suitable day of the week/time of the day for each customer to receive the promotional material 404 in order to increase the likelihood of achieving the predefined objective of increasing sales revenue. It is understood that recommendations may similarly be generated for scenarios related to online and/or offline campaign management of visitors on a website.

It is noted that the correction to the initial estimate of the customer value is explained herein with reference to aggregate persona type and that the instantaneous persona type was not identified for the customer given the offline nature of the enterprise objective (i.e. provisioning of promotional material to most suitable customers). An example generation of recommendation based on corrected estimate of customer value for a customer while taking into account the customer's instantaneous and aggregate persona type is explained hereinafter.

As explained with reference to FIG. 2, for a customer who is currently present on an enterprise interaction channel, the system 200 may be caused to identify both the aggregate persona type (for example, using interaction data from past interactions) and the instantaneous persona type (for example, by using interaction data from current activity on the interaction channel. Additionally, the system 200 may also be caused to predict a propensity of the customer to perform at least one action based on a current activity of the customer during an ongoing interaction on an interaction channel. Some non-limiting examples of the actions include purchasing one or more products of the enterprise, availing a service offered by the enterprise, interacting with an agent over one or more interaction channels, and socializing at least one of a product, a purchase, a good sentiment, a bad sentiment, a brand, an experience and a feeling. More specifically, the system 200 may be caused to predict a likelihood of a customer purchasing a product or availing a service, of being serviced for a particular customer query, of customer posting a comment or tweeting about a product or a service or about the enterprise on social media, and the like. In order to predict a propensity of the customer to perform a purchase transaction or any such action, the system 200 is configured to transform the received interaction data corresponding to the current activity of the customer on the interaction channel to generate a plurality of feature vectors. As explained above, various types of data may be captured corresponding to the customer activity on the interaction channel. For example, for customer's presence on a chat interaction channel, conversational content related to the chat conversation including information such as a type of customer concern, which agent handled the chat interaction, customer concern resolution status, time involved in the chat interaction and the like, may be captured as interaction data. Similarly, for a customer's presence on an enterprise website, the interaction data captured may include information such as web pages visited, time spent on each web page, menu options accessed, drop-down options selected or clicked, mouse movements, hypertext mark-up language (HTML) links those which are clicked and those which are not clicked, focus events (for example, events during which the customer has focused on a link/webpage for a more than a pre-determined amount of time), non-focus events (for example, choices the customer did not make from information presented to the customer (for examples, products not selected) or non-viewed content derived from scroll history of the visitor), touch events (for example, events involving a touch gesture on a touch-sensitive device such as a tablet), non-touch events and the like.

Such interaction data may be captured in substantially real-time and provisioned to the I/O module 206 of the system 200. The processor 202 may then be configured to transform or convert the received interaction data into a more meaningful or useful form. In an illustrative example, the transformation of the interaction data may include normalization of content included therein. In at least one example embodiment, the normalization of the content is performed to standardize spelling, dates and email addresses, disambiguate punctuation, etc. In some embodiments, the processor 202 may also be caused to normalize word classes, URLs, symbols, days of week, digits, and so on. Some non-exhaustive examples of the operations performed by the processor 202 for normalization of content include converting all characters in the text data to lowercase letters, stemming, stop-word removal, spell checking, regular expression replacement, removing all characters and symbols that are not letters in the English alphabet, substituting symbols, abbreviations, and word classes with English words, and replacing two or more space characters, tab delimiters, and newline characters with a single space character etc. It is noted that normalization of content is explained herein using text categorization models for illustration purposes only, and that various models may be deployed for normalization of content, which include a combination of structured and unstructured data.

In an embodiment, the transformation of the information may also involve clustering of content included therein. At least one clustering algorithm from among K-means algorithm, a self-organizing map (SOM) based algorithm, a self-organizing feature map (SOFM) based algorithm, a density-based spatial clustering algorithm, an optics clustering based algorithm and the like, may be used for clustering of information included in the interaction data.

In an embodiment, the processor 202 is further caused to extract features from the transformed data to look for occurrences of contiguous sequences of words in n-gram based features. The n-gram based features may include three unigrams in which words a, b, and c occur, two bi-grams in which two pairs of words occur, one tri-gram in which three specific single words occur, and the like. Types of features can include co-occurrence features where words are not contiguous but co-occur in, for example, a phrase. In some embodiments, the processor 202 may also be configured to perform weighting of features.

The generated feature vectors from the transformed interaction data are then be provided to at least one classifier associated with intention prediction to facilitate prediction of the at least one intention of customer to perform an action, or in other words, the propensity of the customer to perform an action. In at least one example embodiment, the memory 204 is configured to store one or more text mining and intention prediction models as classifiers. The processor 202 of the system 200 may be caused to provision the feature vectors generated upon transformation of the interaction data to the classifiers to facilitate prediction of customer propensity.

The feature vectors provisioned to the classifiers may include, but are not limited to, any combinations of word features such as n-grams, unigrams, bigrams and trigrams, word phrases, part-of-speech of words, sentiment of words, sentiment of sentences, position of words, visitor keyword searches, visitor click data, visitor web journeys, cross-channel journeys, the visitor interaction history and the like. In an embodiment, the classifiers may utilize any combination of the above-mentioned input features to predict the customer's likely intents. In an embodiment, an intention predicted for the customer corresponds to an outcome (such as for example a ‘YES’ or a ‘No’ outcome or even a ‘High’ or a ‘Low’ outcome) related to one of a propensity of the customer to engage in a chat interaction, a propensity of the customer to make a purchase on the website and a propensity of the customer to purchase a specific product displayed on the website. Further, in at least one example embodiment, the outcome may be associated with a likelihood measure. For example, an outcome of predicted propensity of the customer to perform an action, such as a purchase transaction, may be ‘Yes’ and may further associated with a likelihood measure of ‘0.85’ indicative of a 85% likelihood of the customer performing the purchase transaction during the current interaction.

In at least one example embodiment, the system 200 is caused to utilize a persona type identified for the customer in the model for predicting any response variable or outcome or action, for example, purchase propensity, to fine-tune the likelihood measure associated with the predicted propensity of the customer to perform an action. For example, if a customer is associated with an aggregate persona type of a ‘naïve customer’ (i.e. naïve in terms of technical skills) or a ‘non-geek customer’ and if currently the customer is browsing through Linux enabled laptops (having previously brought Windows devices), then a likelihood measure of the customer indulging in a purchase transaction may be reduced to reflect the decreased likelihood of customer purchasing a Linux enabled laptop.

Further, in at least one example embodiment, the system 200 may be caused to generate one or more recommendations based on the predicted propensity of the customer to perform an action, such as, to make a purchase, and the corrected estimate of the customer value. Further, the system 200 may be caused to provide the generated recommendations to an agent of the enterprise to facilitate implementation of the one or more recommendations for achieving the one or more predefined objectives of the enterprise. An example provisioning of the generated recommendations to agents is explained with reference to FIG. 5.

FIG. 5 shows a simplified representation 500 of agents assisting customers of an enterprise based on recommendations generated by the system 200 of FIG. 2, in accordance with an embodiment of the invention. More specifically, the simplified representation 500 depicts two example customers 502 and 504 of an enterprise (not shown in FIG. 5). It is understood that the enterprise may be a corporation, an institution, a small/medium sized company or even a brick and mortar entity. For example, the enterprise may be a banking enterprise, an educational institution, a financial trading enterprise, an aviation company, a retail outlet or any such public or private sector enterprise.

In an example scenario, the customer 502 may be currently present on an enterprise website and the customer's current activity may include visit to web pages related to ‘Help’ and the ‘Frequently asked questions’. As explained with reference to FIG. 2, the system 200 may be caused to determine an initial estimate of a customer value for the customer 502. Furthermore, an aggregate persona type may be identified for the customer 502. In an illustrative example, the aggregate persona type identified for the customer 502 may be ‘Enquirer’, indicative of the customer's behavioral trait of asking number of questions. Moreover, the instantaneous persona type identified for the customer 502 may be ‘Researcher’ given the current activity of the customer 502 on the website (for example, current activity of the customer 502 involving browsing through product specifications). In an illustrative example, the aggregate persona type and the instantaneous persona types may be associated with pre-determined correction factors of ‘1’ and ‘0.85’, respectively. As explained with reference to FIG. 2, the system 200 may be caused to correct the estimate of the customer value based on the correction factors (for example, multiply the initial estimate of the customer value with weighted measures of the correction factor) to generate the corrected estimate of the customer value.

Further, based on the current activity of the customer 502 on the website, the system 200 may be caused to predict a purchase propensity of the customer 502. The propensity of a customer 502 to perform an action may be predicted as explained with reference to FIG. 2 and is not explained herein. Based on the corrected estimate of the customer value and the predicted purchasing propensity of the customer 502, the system 200 may be caused to generate one or more recommendations. For example, if the corrected estimate of the customer value is quite low and the predicted purchasing propensity of the customer 502 is low, then the system 200 may be caused to de-prioritize the customer 502 over other customers and suggest an agent to push ‘informational self-help widgets’ on the website to assist the customer 502. However, if the corrected estimate of the customer value is low and the predicted purchasing propensity of the customer 502 is high, then the system 200 may be caused to suggest to an agent to proactively offer chat assistance to the customer 502 to aid the customer 502 with the potential purchase transaction. In a scenario, where the corrected estimate of the customer value is high and the predicted purchasing propensity of the customer 502 is high, then the system 200 may be caused to suggest initiating a voice call interaction between an agent and the customer 502 and further suggest routing the interaction to an agent, such as an agent 506, who is verbose and is capable of handling many questions from the customer 502 (i.e. an agent with persona type matching the customer's persona type of an enquirer′).

In another example scenario, the customer 504 may be currently present on a chat interaction channel, i.e. the customer 504 may be engaged in a chat interaction with the agent 508. The customer 504 may have initiated a chat interaction with the agent 508 to known about various data plans offered by a telecommunication enterprise. As explained with reference to FIG. 2, the system 200 may be caused to determine an initial estimate of a customer value for the customer 504. Furthermore, an aggregate persona type may be identified for the customer 504. In an illustrative example, the aggregate persona type identified for the customer 504 may be ‘Open’ persona type, indicative of the customer's behavioral trait of being flexible to options for purchase. Moreover, the instantaneous persona type identified for the customer 504 may be ‘Naïve customer’ given the questions the customer is asking to the agent 508. In an illustrative example, the aggregate persona type and the instantaneous persona types may be associated with pre-determined correction factors of ‘1.2’ and ‘1.1’, respectively. As explained with reference to FIG. 2, the system 200 may be caused to correct the initial estimate of the customer value based on the correction factors (for example, multiply the customer value with weighted measures of the correction factor) to generate the corrected estimate of the customer value.

Further, based on the current conversation of the customer 504 with the agent, the system 200 may be caused to predict a purchase propensity of the customer 504. Based on the corrected estimate of the customer value and the predicted purchasing propensity of the customer 504, the system 200 may be caused to generate one or more recommendations. For example, if the corrected estimate of the customer value is high and the predicted purchasing propensity of the customer 504 is high, then the system 200 may be caused to recommend to the agent 508 to offer a 80 US dollar data plan given the customer's needs as opposed to 60 US dollar data plan that the customer 504 is currently enquiring about. Accordingly, the system 200 may take into account the ‘open’ and ‘naïve’ persona type of the customer 504 to push a better billing plan to the customer 504. In an illustrative example, the system 200 may also be caused to recommend to the agent 508 to provision a self-help web link to enable the customer 504 to plug his requirement and choose a suitable plan for him/her.

Referring now to FIG. 2, as explained, the corrected estimate of the customer value may be generated while taking into account the behavioral characteristics of the customer (or the customer persona type). In an embodiment, the corrected estimate of the customer value may be further refined based on experience of a customer during previous interactions. For example, the customer may have previously faced problem in finding information on a website, or faced website errors, or even had problem in checking out during a purchase. In such cases, the corrected estimate of the customer value may accordingly be refined (for example, lowered). In an embodiment, the corrected estimate of the customer value of the customer may be adjusted based on predicted net experience score of the customer for each interaction on one or more interaction channels.

Further, in some embodiments, the processor 202 is configured to associate a value with each customer interaction. In a situation, where the interaction ended with a low customer experience or where the customer did not purchase goods or services, which were intended to be purchased, then the processor 202 may log the interaction value as ‘revenue loss’ (or perceived revenue loss). In an embodiment, the revenue loss insights may be used by businesses/enterprises to further automatically optimize the customer value based persona models and the treatment provided to the customer further be personalized. This is further explained with reference to a following illustrative example. In an example scenario, the processor 202 may have predicted high purchase propensity for a current interaction journey of the customer, who was also associated with high customer value. Further, the customer, as predicted may have added high value goods to the cart, however before concluding the purchase customer wanted to have certain queries answered, but was made to wait in a long queue or was directed to an agent who was not proficient in such issues which resulted in customer abandoning the cart. In such case the value of the cart items and be logged as revenue loss or potential revenue loss. This information along with interaction information may be used to further optimize recommendation generation systems, staffing systems, diverting/routing techniques as well as for modeling agent performances. Accordingly, the customer may be treated differentially (for example, routed to the most suitable agent or routed to a queue with least waiting time, or even provided immediate agent assistance) during a subsequent journey of the customer on an enterprise interaction channel.

In some embodiments, the system 200 may be caused to determine an estimate of a customer value for a customer of an enterprise based on a current activity of the customer on at least one interaction channel. In an embodiment, the estimate of the customer value may be determined based on value of products or services viewed or enquired by the customer during the current activity of the customer on the at least one interaction channel. For example, if the customer is viewing a high value product, such as a high end phone or a designer apparel, then the estimate of the customer value may be determined to be an average value of the products viewed during a current web session of the customer. In another illustrative example, if the customer has enquired about purchasing a business-class air fare ticket to an exotic holiday destination, then the estimate of the customer value may be determined to be the average business-class fare tickets for such flight trips. It is noted that in such scenarios, the customer value is computed solely based on a current activity of the customer on an enterprise interaction channel and precludes customer value estimation based on previous interactions or previous transactions. Further, the system 200 may be caused to determine if the estimate of the customer value is greater than a pre-determined threshold value. In an illustrative example, the pre-determined threshold value may be a numerical value, for example 1500 US dollars. If the estimate of customer value based on products/services being viewed or enquired by the customer exceeds the pre-determined threshold value, then the system 200 may be caused to identify a target treatment for the customer using interaction data associated with past interactions of the customer with the enterprise on one or more interaction channels. In other words, the system 200 may be caused to identify the customer's historical preferences or historical treatments afforded to the customer from past interactions. For example, an identified target treatment may be to offer a promotional offer to the customer for the product being currently viewed on the website. In another illustrative example, the identified target treatment may be to proactively initiate an agent interaction with the customer. The system 200 may further be caused to facilitate a provisioning of at least one of a personalized treatment and a preferential treatment to the customer during the current activity of the customer on the at least one interaction channel based on the identified target treatment. The provisioning of the personalized treatment and/or the preferential treatment may be performed as explained earlier and is not explained again herein. In some embodiments, the estimate of the customer value determined based on value of products viewed or enquired by the customer during the current activity of the customer on the at least one interaction channel may be corrected using aggregate and/or instantaneous persona type identified for the customer. The provisioning of the personalized and/or preferential treatment may further be performed based on the corrected estimate of the customer value.

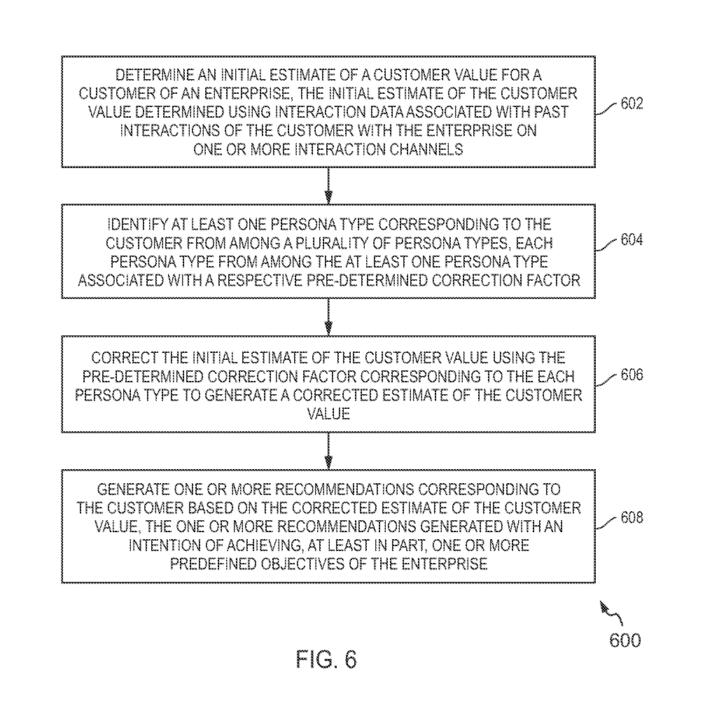

A method for effecting customer value based customer interaction management is explained with reference to FIG. 6.

FIG. 6 is a flow diagram of an example method 600 for effecting customer value based customer interaction management, in accordance with an embodiment of the invention. The method 600 depicted in the flow diagram may be executed by, for example, the system 200 explained with reference to FIGS. 2 to 5. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with help of the system 200. It is noted that, the operations of the method 600 can be described and/or practiced by using a system other than the system 200. The method 600 starts at operation 602.

At operation 602 of the method 600, an initial estimate of a customer value is determined for a customer of an enterprise. In at least one example embodiment, the initial estimate of the customer value is determined using interaction data associated with past interactions of the customer with the enterprise on one or more interaction channels.

In an illustrative example, the initial estimate of customer value may be determined in form a Customer Lifetime Value (CLV) estimate. It is understood the CLV estimate may be determined using various known techniques. For example, the CLV estimate may be determined using Recency-Frequency-Monetary Value (RFM) approach, which models the customer value as a function of how recently the customer interacted with the enterprise, a frequency of customer interactions and monetary values of customer transactions associated with the customer interactions. As explained with reference to FIG. 2, the customer value may be estimated in other forms and may not be limited to a CLV estimate based on RFM based approach. Moreover, the CLV estimate may be determined using any one of several models like those based on stochastic modeling, Markov models, Markov decision process (MDP), policy iteration algorithms for infinite horizon problems, value iteration algorithms for finite horizon problems, survival models, retention or chum models and the like, and may not be limited to the RFM approach. Such approaches model CLV as a function of recency, frequency, monetary value, discount rate, chum/retention rate, acquisition rate, retention costs, acquisition costs, revenue, advertising or campaign cost, cost of serving the customers, state transition probability matrix, and the like.

At operation 604 of the method 600, at least one persona type is identified corresponding to the customer from among a plurality of persona types. As explained with reference to FIG. 2, the term ‘persona type’ or ‘persona’ refers to characteristics reflecting behavioral patterns, goals, motives and personal values of the customer. In an embodiment, an aggregate persona type may be identified for the customer based on stored interaction data corresponding to the customer. To that effect, an appropriate customer persona classification framework or taxonomy of persona types may be selected based on factors such as predefined objective(s) and/or interaction channels associated with customer interactions. Some non-limiting examples of predefined objectives may include a sales objective, a service objective, an influence objective (i.e. ability of an agent to influence a consumer to make a purchase) and the like. The various examples of predefined objectives are explained with reference to FIG. 2 and are not explained again herein.

In an embodiment, the interaction data collated corresponding to the customer from past interactions may be analyzed to identify behavioral traits associated with the customer during various past interactions. The behavioral traits exhibited, mentioned, inferred or predicted based on past interaction history may be compared with sets of behavioral traits associated with the plurality of persona types in the selected customer persona classification framework to identify a presence of a match. The matching persona type may then be identified as the aggregate persona type of the customer. It is noted that in some embodiments, the aggregate persona type may be identified from the customer persona classification framework using predictive models.

In some embodiments, in addition to identifying the aggregate persona type, an instantaneous persona type may be identified corresponding to the customer based on the current activity of the customer on the interaction channel. More specifically, for a customer, who is not currently engaged in an interaction with the enterprise (for example, not active on an enterprise website or interacting with an agent associated with the enterprise), then for such a customer, only an aggregate persona type may be identified. However, if the customer is currently active on an enterprise interaction channel, then an instantaneous persona type may also be identified for the customer. In such a scenario, based on the predefined objective and/or current interaction channel, a customer persona classification framework may be selected from among the plurality of customer persona classification frameworks. As explained above, each customer persona classification framework is associated with one or more persona types. An instantaneous persona type corresponding to the customer may be determined based on the selected customer persona classification framework and the current activity of the customer on the interaction channel.

In at least one example embodiment, each persona type is associated with a respective pre-determined correction factor. The determination of a correction factor may be performed based on observed as well as experimental analysis of the effect of a particular persona type on a subsequent propensity of the customer to perform an action, such as for example, perform a purchase transaction during the current interaction. In at least one example embodiment, the correction factor may be a numerical value. For example, for a persona type ‘impulsive buyer’, who can be lured to make a purchase by showcasing suitable promotional offers may be associated with a pre-determined correction factor of ‘1.2’. However, for a persona type ‘geek’, i.e. a customer who will thoroughly analyze the technical specifications of products and will make a purchase only after review of several competing products may be associated with a pre-determined correction factor of ‘0.7’. Accordingly, each of the aggregate and the instantaneous persona types may be associated with respective pre-determined correction factors.

At operation 606 of the method 600, the initial estimate of the customer value is corrected using the pre-determined correction factor corresponding to the each persona type to generate a corrected estimate of the customer value. For example, if the aggregate persona type is associated with a pre-determined correction factor of ‘0.85’ and if the initial estimate of the customer value is 1000 US dollars, then the corrected estimate of the customer value may be determined, in one example embodiment, by simply multiplying the pre-determined correction factor with the initial estimate of the customer value, i.e. 0.85×1000, to generate the corrected estimate of customer value of 850 US dollars. In an illustrative example, if an instantaneous persona type is also identified for the customer and the instantaneous persona type is associated with a correction factor of ‘1.2’ then the final corrected estimate of the customer value may be determined, in one example embodiment, by simply multiplying the pre-determined correction factor with the corrected estimate of the customer value, i.e. 1.2×850, to generate the corrected estimate of customer value of 1020 US dollars. Such a correction of the customer value estimate enables the enterprise to take historic as well as current behavioral attributes of the customer into account while determining a target strategy for the customer.

At operation 608 of the method 600, one or more recommendations are generated corresponding to the customer based on the corrected estimate of the customer value. In an embodiment, the one or more recommendations are generated with an intention of achieving, at least in part, one or more predefined objectives of the enterprise. For example, if the predefined objective is a sales objective, i.e. to increase sales revenue, then the one or more recommendations may be generated with an intention of achieving such an objective. In an illustrative example, based on the corrected estimate of the customer value, an example recommendation generated may be to offer a discount coupon to the customer as the corrected estimate of the customer value (for example, a higher value) indicates that the customer is more likely to buy when offered a discount. In the absence of such a persona type based correction to the customer value, all customers with similar customer values may be treated in a generic manner, thereby reducing an impact of such a customer targeting strategy.

Some other examples of recommendations generated based on the corrected estimate of the customer value of a customer may include, but are not limited to, recommending up sell/cross-sell products to the customer, suggesting products to up sell/cross-sell to agent as a recommendation, offering a suggestion for a discount to the agent as a recommendation, recommending a style of conversation to the agent during an interaction, presenting a different set of productivity or visual widgets to the agent to facilitate personalization of interaction with specific persona types on the agent interaction platform, presenting a different set of productivity or visual widgets to the customers with specific persona types on the customer interaction platform, proactive interaction, customizing the speed of interaction, customizing the speed of servicing information and the like.

In some embodiments, a provisioning of at least one of a personalized treatment and a preferential treatment to the customer may be facilitated based on the one or more recommendations. Some non-limiting examples of personalized treatment provisioned to the customer may include sending a self serve link to the customer, sharing a knowledge base article, providing resolution to a customer query over an appropriate interaction channel, escalating or suggesting escalation of customer service level, offering a discount to the customer, recommending products to the customer for up-sell/cross-sell, proactively offering interaction, customizing the speed of interaction, customizing the speed of servicing information, deflecting interaction to a different interaction channel historically preferred by the customer and the like. Some non-limiting examples of preferential treatment provisioned to the customer may include routing an interaction to an agent with the best matching persona type, routing the interaction to a queue with the least waiting time, providing immediate agent assistance, etc. In at least some embodiments, the personalized treatment and/or the preferential treatment may be provisioned to the customer based on interaction data associated with past interactions of the customer with the enterprise on one or more interaction channels.

In an embodiment, the customer value may be further adjusted based on experience of a customer during previous interactions. For example, the customer may have previously faced problem in finding information on a website, or faced website errors, or even had problem in checking out during a purchase. In such cases, the customer value may accordingly be refined (for example, lowered). In an embodiment, the customer value of the customer may be adjusted based on predicted net experience score of the customer for each interaction on one or more interaction channels.

Further, in some embodiments, a value of each interaction and/or value of the instantaneous transaction may be computed, and this value may be logged as ‘revenue loss’ in cases where the interaction ended with a low customer experience or where the customer did not purchase goods or services, which were intended to be purchased. The revenue loss insights may be used by businesses/enterprises to further automatically optimize the customer value based persona models and the treatment provided to the customer may further be personalized as explained with reference to FIG. 2.

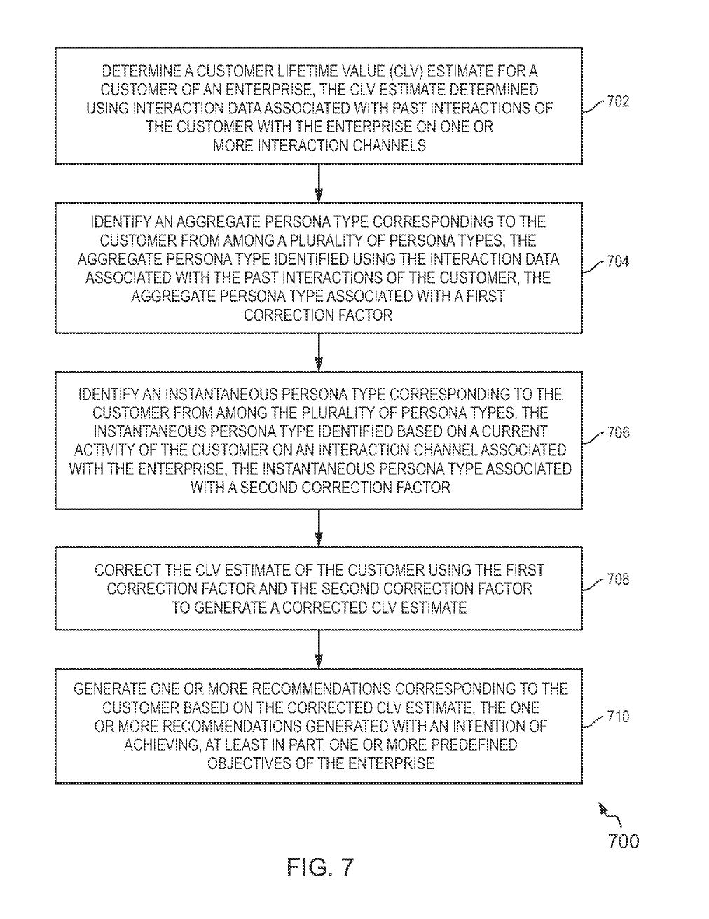

The method 600 stops at operation 608. Another method for effecting customer value based customer interaction management is explained with reference to FIG. 7.

FIG. 7 is a flow diagram of an example method 700 for effecting customer value based customer interaction management, in accordance with another embodiment of the invention. The method 700 depicted in the flow diagram may be executed by, for example, the system 200 explained with reference to FIGS. 2 to 5. Operations of the flowchart, and combinations of operation in the flowchart, may be implemented by, for example, hardware, firmware, a processor, circuitry and/or a different device associated with the execution of software that includes one or more computer program instructions. The method 700 starts at operation 702.

At operation 702 of the method 700, a customer lifetime value (CLV) estimate is determined for a customer of an enterprise. The CLV estimate is determined using interaction data associated with past interactions of the customer with the enterprise on one or more interaction channels.

At operation 704 of the method 700, an aggregate persona type corresponding to the customer is identified from among a plurality of persona types. The aggregate persona type is identified using the interaction data associated with the past interactions of the customer. In an embodiment, the aggregate persona type is associated with a first correction factor. As explained with reference to FIG. 2, each persona type in a customer persona classification framework is associated with a respective pre-determined correction factor. Accordingly, the aggregate persona type may also be associated with a respective pre-determined correction factor, referred to herein as the first correction factor.

At operation 706 of the method 700, an instantaneous persona type corresponding to the customer is identified from among the plurality of persona types. The instantaneous persona type is identified based on a current activity of the customer on an interaction channel associated with the enterprise. In an embodiment, the instantaneous persona type is associated with a second correction factor. As explained with reference to FIG. 2, each persona type in a customer persona classification framework is associated with a respective pre-determined correction factor. Accordingly, the instantaneous persona type may also be associated with a respective pre-determined correction factor, referred to herein as the second correction factor.

At operation 708 of the method 700, the CLV estimate of the customer is corrected using the first correction factor and the second correction factor to generate a corrected CLV estimate.

At operation 710 of the method 700, one or more recommendations corresponding to the customer are generated based on the corrected CLV estimate. The one or more recommendations are generated with an intention of achieving, at least in part, one or more predefined objectives of the enterprise. The correction of the CLV estimate and the generation of the one or more recommendations may be performed as explained with reference to FIG. 2 and are not explained herein.

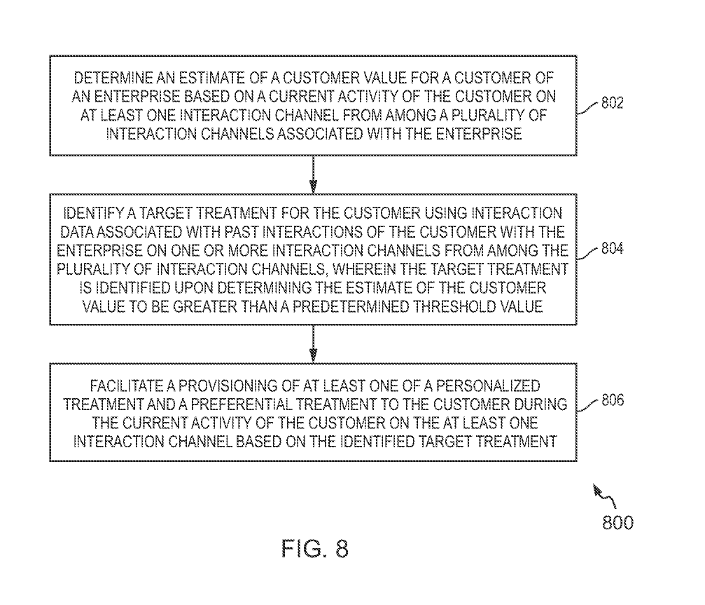

Another method for effecting customer value based customer interaction management is explained with reference to FIG. 8.

FIG. 8 is a flow diagram of an example method 800 for effecting customer value based customer interaction management, in accordance with another embodiment of the invention. The method 800 depicted in the flow diagram may be executed by, for example, the system 200 explained with reference to FIGS. 2 to 5. Operations of the flowchart, and combinations of operation in the flowchart, may be implemented by, for example, hardware, firmware, a processor, circuitry and/or a different device associated with the execution of software that includes one or more computer program instructions. The method 800 starts at operation 802.

At operation 802 of the method 800, an estimate of a customer value is determined for a customer of an enterprise based on a current activity of the customer on at least one interaction channel from among a plurality of interaction channels associated with the enterprise. In an embodiment, the estimate of the customer value may be determined based on value of products or services viewed or enquired by the customer during the current activity of the customer on the at least one interaction channel. For example, if the customer is viewing a high value product, such as a high end phone or a designer apparel, then the estimate of the customer value may be determined to be an average value of the products viewed during a current web session of the customer. In another illustrative example, if the customer has enquired about purchasing a business-class air fare ticket to an exotic holiday destination, then the estimate of the customer value may be determined to be the average business-class fare tickets for such flight trips. It is noted that in such scenarios, the customer value is computed solely based on a current activity of the customer on an enterprise interaction channel and precludes customer value estimation based on previous interactions or previous transactions.

At operation 804 of the method 800, a target treatment is identified for the customer using interaction data associated with past interactions of the customer with the enterprise on one or more interaction channels from among the plurality of interaction channels. For example, an identified target treatment may be to offer a promotional offer to the customer for the product being currently viewed on the website. In another illustrative example, the identified target treatment may be to proactively initiate an agent interaction with the customer. In an embodiment, the target treatment is identified upon determining the estimate of the customer value to be greater than a pre-determined threshold value. In an illustrative example, the pre-determined threshold value may be a numerical value, for example 1500 US dollars. If the estimate of customer value based on products/services being viewed or enquired by the customer exceeds the pre-determined threshold value, then the target treatment may be identified for the customer using interaction data associated with past interactions of the customer with the enterprise on one or more interaction channels.

At operation 806 of the method 800, a provisioning of at least one of a personalized treatment and a preferential treatment to the customer is facilitated during the current activity of the customer on the at least one interaction channel based on the identified target treatment. The provisioning of the personalized treatment and/or the preferential treatment is explained with reference to FIG. 2 and is not explained again herein.

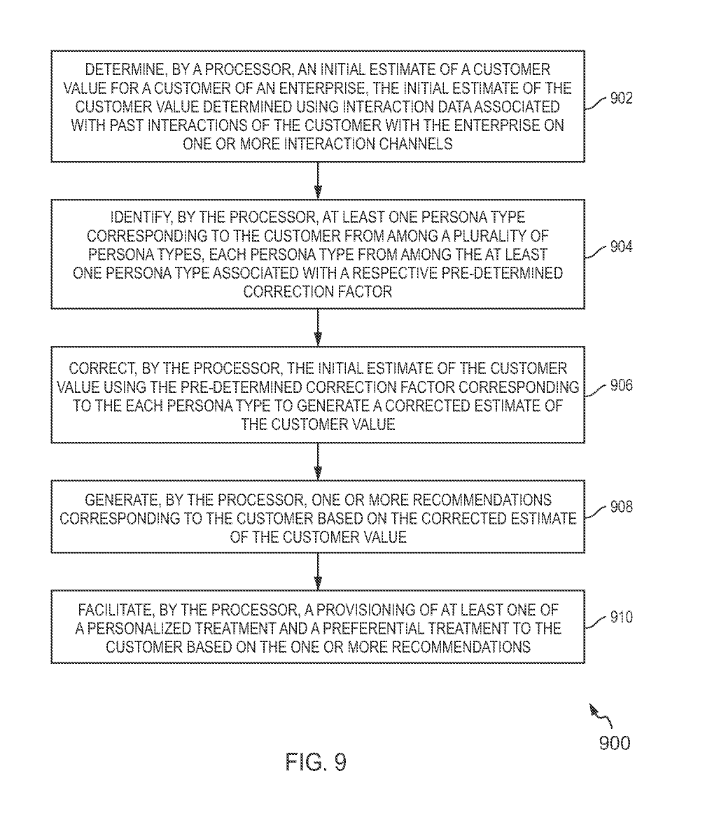

Another method for effecting customer value based customer interaction management is explained with reference to FIG. 9.

FIG. 9 is a flow diagram of an example method 900 for effecting customer value based customer interaction management, in accordance with another embodiment of the invention. The method 900 depicted in the flow diagram may be executed by, for example, the system 200 explained with reference to FIGS. 2 to 5. Operations of the flowchart, and combinations of operation in the flowchart, may be implemented by, for example, hardware, firmware, a processor, circuitry and/or a different device associated with the execution of software that includes one or more computer program instructions. The method 900 starts at operation 902.

At operation 902 of the method 900, an initial estimate of a customer value is determined by a processor, such as the processor 202 of FIG. 2, for a customer of an enterprise. In at least one example embodiment, the initial estimate of the customer value is determined using interaction data associated with past interactions of the customer with the enterprise on one or more interaction channels. At operation 904 of the method 900, at least one persona type is identified corresponding to the customer from among a plurality of persona types by the processor. In at least one example embodiment, each persona type is associated with a respective pre-determined correction factor. At operation 906 of the method 900, the initial estimate of the customer value is corrected by the processor using the pre-determined correction factor corresponding to the each persona type to generate a corrected estimate of the customer value. The operations 902, 904 and 906 may be performed as explained with reference to operations 602, 604 and 606 of the method 600 in FIG. 6, respectively and are not explained herein.

At operation 908 of the method 900, one or more recommendations are generated corresponding to the customer by the processor based on the corrected estimate of the customer value. The generation of the one or more recommendations may be performed as explained with reference to FIGS. 2 to 5. At operation 910 of the method 900, a provisioning of at least one of a personalized treatment and a preferential treatment to the customer is facilitated by the processor based on the one or more recommendations. The provisioning of the personalized treatment and/or the preferential treatment is explained with reference to FIG. 2 and is not explained again herein.

Without in any way limiting the scope, interpretation, or application of the claims appearing below, advantages of one or more of the exemplary embodiments disclosed herein provide numerous advantages. The techniques disclosed herein enable enterprises to determine customer value more accurately. More specifically, a value of a customer relationship is determined in an accurate manner by taking into account the customer's behavioral attributes or a customer's persona. Further, the estimation of customer value is based on the monetary value that factors in the historic products purchased and the products that the customer has expressed interest in, on any one or more interaction channels. This is an improvement on the traditional approaches that calculate customer value on a single channel, and may determine the monetary value based only on the products purchased. Such computation of customer values enables the enterprises to better segment customers into suitable categories in order to treat each customer differentially based on the customer value. For example, the enterprises may determine most valuable customers based on customer value and provide suitable recommendation or discounts, or route their interactions to best-matched agents instead of providing such treatment to less valuable customers.

Further, a performance of customer value based customer interaction management programs may be monitored in real-time based on a revenue opportunity metric, such as for example, a difference between the revenue realized and potential revenue opportunity quantified based on corrected CLV estimate based interaction management for various customer segments. Such performance monitoring may help in optimizing programs better than the traditional approaches of monitoring only the revenues and conversion rates for the customers. Further, using such an approach, more focused target groups can be identified by suitably building targeting models to optimize the chosen revenue metric.

Various embodiments described above may be implemented in software, hardware, application logic or a combination of software, hardware and application logic. The software, application logic and/or hardware may reside on one or more memory locations, one or more processors, an electronic device or, a computer program product. In an embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, system, or device, as described and depicted in FIG. 2. A computer-readable medium may comprise a computer-readable storage medium that may be any media or means that can contain or store the instructions for use by or in connection with an instruction execution system, system, or device, such as a computer.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 200, the processor 202, the memory 204 and the I/O module 206 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIGS. 6, 7, 8, and 9). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations, which are different than those which, are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
determining, by a processor, an initial estimate of a customer value for a customer of an enterprise, the initial estimate of the customer value determined using interaction data associated with past interactions of the customer with the enterprise on one or more interaction channels;
identifying, by the processor, at least one persona type corresponding to the customer from among a plurality of persona types, each persona type from among the at least one persona type associated with a respective pre-determined correction factor;
correcting, by the processor, the initial estimate of the customer value using the pre-determined correction factor corresponding to the each persona type to generate a corrected estimate of the customer value; and
generating, by the processor, one or more recommendations corresponding to the customer based on the corrected estimate of the customer value, the one or more recommendations generated with an intention of achieving, at least in part, one or more predefined objectives of the enterprise.

2. The method of claim 1, wherein determining the initial estimate of the customer value comprises computing a customer lifetime value (CLV) estimate for the customer using the interaction data, the computed CLV estimate configured to serve as the initial estimate of the customer value for the customer.

3. The method of claim 2, wherein the CLV estimate is computed based on at least one of a recency of interactions of the customer with the enterprise, a frequency of the interactions of the customer with the enterprise and monetary values of transactions associated with the interactions of the customer with the enterprise.

4. The method of claim 1, wherein the at least one persona type comprises an aggregate persona type and an instantaneous persona type corresponding to the customer, the aggregate persona type identified using the interaction data associated with the past interactions of the customer and the instantaneous persona type identified based on a current activity of the customer on an interaction channel associated with the enterprise.

5. The method of claim 4, wherein the identification of the instantaneous persona type further comprises:
receiving, by the processor, an input corresponding to the one or more predefined objectives of the enterprise and the interaction channel associated with the current activity of the customer; and
selecting, by the processor, a customer persona classification framework from among a plurality of customer persona classification frameworks based on the input, each customer persona classification framework from among the plurality of customer persona classification frameworks associated with one or more persona types, wherein the identification of the instantaneous persona type corresponding to the customer is performed based on the selected customer persona classification framework and the current activity of the customer on the interaction channel.

6. The method of claim 5, wherein a predefined objective from among the one or more predefined objectives is one of a sales objective and a service objective, and wherein the sales objective is indicative of a goal of increasing sales revenue of the enterprise and the service objective is indicative of a motive of improving interaction experience of the customer.

7. The method of claim 5, wherein the interaction channel is one of a web channel, a chat channel, a voice channel, a social channel, an interactive voice response (IVR) channel and a native application channel.

8. The method of claim 1, further comprising:
predicting, by the processor, a propensity of the customer to perform at least one action based on a current activity of the customer during an ongoing interaction on an interaction channel associated with the enterprise, wherein the one or more recommendations are generated based on the predicted propensity of the customer and the corrected estimate of the customer value.

9. The method of claim 8, wherein an action from among the at least one action corresponds to one of purchasing one or more products of the enterprise, availing a service offered by the enterprise, interacting with an agent over the one or more interaction channels, and socializing at least one of a product, a purchase, a good sentiment, a bad sentiment, a brand, an experience and a feeling.

10. The method of claim 1, further comprising:
providing the one or more recommendations, by the processor, to an agent of the enterprise to facilitate implementation of the one or more recommendations for achieving the one or more predefined objectives of the enterprise.

11. The method of claim 1, further comprising:
facilitating, by the processor, a provisioning of at least one of a personalized treatment and a preferential treatment to the customer based on the one or more recommendations.

12. The method of claim 1, further comprising:
performing, by the processor, steps of determining the initial estimate of the customer value, identifying the at least one persona type and correcting the initial estimate of the customer value for each customer from among a plurality of customers in a customer segment to generate a set of corrected estimates of the customer values corresponding to the plurality of customers in the customer segment.

13. The method of claim 12, wherein the one or more recommendations are generated corresponding to at least one of inventory stock management, staffing level of agents, in-session customer targeting of the customers, post-session targeting of the customers, dynamic pricing of enterprise offerings and service level escalation based on the set of corrected estimates of the customer values for the plurality of customers in the customer segment.

14. The method of claim 1, further comprising:
refining, by the processor, the corrected estimate of the customer value for the customer based on an experience of the customer during one or more previous interactions with the enterprise.

15. An system, comprising:
at least one processor; and
a memory having stored therein machine executable instructions, that when executed by the at least one processor, cause the system to:
determine an initial estimate of a customer value for a customer of an enterprise, the initial estimate of the customer value determined using interaction data associated with past interactions of the customer with the enterprise on one or more interaction channels;
identify at least one persona type corresponding to the customer from among a plurality of persona types, each persona type from among the at least one persona type associated with a respective pre-determined correction factor;
correct the initial estimate of the customer value using the pre-determined correction factor corresponding to the each persona type to generate a corrected estimate of the customer value; and
generate one or more recommendations corresponding to the customer based on the corrected estimate of the customer value, the one or more recommendations generated with an intention of achieving, at least in part, one or more predefined objectives of the enterprise.

16. The system of claim 15, wherein the system is caused to:
compute a customer lifetime value (CLV) estimate for the customer to determine the initial estimate of the customer value for the customer, the CLV estimate computed using the interaction data associated with the past interactions of the customer with the enterprise.

17. The system of claim 16, wherein the CLV estimate is computed based on at least one of a recency of interactions of the customer with the enterprise, a frequency of the interactions of the customer with the enterprise and monetary values of transactions associated with the interactions of the customer with the enterprise.

18. The system of claim 15, wherein the at least one persona type comprises an aggregate persona type and an instantaneous persona type corresponding to the customer, the aggregate persona type identified using the interaction data associated with the past interactions of the customer and the instantaneous persona type identified based on a current activity of the customer on an interaction channel associated with the enterprise.

19. The system of claim 18, wherein to identify the instantaneous persona type, the system is further caused to:
receive an input corresponding to the one or more predefined objectives of the enterprise and the interaction channel associated with the current activity of the customer; and
select a customer persona classification framework from among a plurality of customer persona classification frameworks based on the input, each customer persona classification framework from among the plurality of customer persona classification frameworks associated with one or more persona types, wherein the identification of the instantaneous persona type corresponding to the customer is performed based on the selected customer persona classification framework and the current activity of the customer on the interaction channel.

20. The system of claim 19, wherein a predefined objective from among the one or more predefined objectives is one of a sales objective and a service objective, and wherein the sales objective is indicative of a goal of increasing sales revenue of the enterprise and the service objective is indicative of a motive of improving interaction experience of the customer.

21. The system of claim 19, wherein the interaction channel is one of a web channel, a chat channel, a voice channel, a social channel, an interactive voice response (IVR) channel and a native application channel.

22. The system of claim 15, wherein the system is further caused to:
predict a propensity of the customer to perform at least one action based on a current activity of the customer during an ongoing interaction on an interaction channel associated with the enterprise, wherein the one or more recommendations are generated based on the predicted propensity of the customer and the corrected estimate of the customer value.

23. The system of claim 22, wherein an action from among the at least one action corresponds to one of purchasing one or more products of the enterprise, availing a service offered by the enterprise, interacting with an agent over the one or more interaction channels, and socializing at least one of a product, a purchase, a good sentiment, a bad sentiment, a brand, an experience and a feeling.

24. The system of claim 15, wherein the system is further caused to:
provision the one or more recommendations to an agent of the enterprise to facilitate implementation of the one or more recommendations for achieving the one or more predefined objectives of the enterprise.

25. The system of claim 15, wherein the system is further caused to:
facilitate provisioning of at least one of a personalized treatment and a preferential treatment to the customer based on the one or more recommendations.

26. The system of claim 15, wherein the system is further caused to:
perform steps of determining the initial estimate of the customer value, identifying the at least one persona type and correcting the initial estimate of the customer value for each customer from among a plurality of customers in a customer segment to generate a set of corrected estimates of the customer values corresponding to the plurality of customers in the customer segment.

27. The system of claim 26, wherein the one or more recommendations are generated corresponding to at least one of inventory stock management, staffing level of agents, in-session customer targeting of the customers, post-session targeting of the customers, dynamic pricing of enterprise offerings and service level escalation based on the set of corrected estimates of the customer values for the plurality of customers in the customer segment.

28. The system of claim 15, wherein the system is further caused to:
refine the corrected estimate of the customer value for the customer based on an experience of the customer during one or more previous interactions with the enterprise.

29. A computer-implemented method comprising:
determining, by a processor, a customer lifetime value (CLV) estimate for a customer of an enterprise, the CLV estimate determined using interaction data associated with past interactions of the customer with the enterprise on one or more interaction channels;
identifying, by the processor, an aggregate persona type corresponding to the customer from among a plurality of persona types, the aggregate persona type identified using the interaction data associated with the past interactions of the customer, the aggregate persona type associated with a first correction factor;
identifying, by the processor, an instantaneous persona type corresponding to the customer from among the plurality of persona types, the instantaneous persona type identified based on a current activity of the customer on an interaction channel associated with the enterprise, the instantaneous persona type associated with a second correction factor;
correcting, by the processor, the CLV estimate of the customer using the first correction factor and the second correction factor to generate a corrected CLV estimate; and
generating, by the processor, one or more recommendations corresponding to the customer based on the corrected CLV estimate, the one or more recommendations generated with an intention of achieving, at least in part, one or more predefined objectives of the enterprise.

30. The method of claim 29, wherein the CLV estimate is determined based on at least one of a recency of interactions of the customer with the enterprise, a frequency of the interactions of the customer with the enterprise and monetary values of transactions associated with the interactions of the customer with the enterprise.

31. The method of claim 29, wherein the identification of the instantaneous persona type further comprises:
receiving, by the processor, an input corresponding to the one or more predefined objectives of the enterprise and the interaction channel associated with the current activity of the customer; and
selecting, by the processor, a customer persona classification framework from among a plurality of customer persona classification frameworks based on the input, each customer persona classification framework from among the plurality of customer persona classification frameworks associated with one or more persona types, wherein the identification of the instantaneous persona type corresponding to the customer is performed based on the selected customer persona classification framework and the current activity of the customer on the interaction channel.

32. The method of claim 31, wherein a predefined objective from among the one or more predefined objectives is one of a sales objective and a service objective, and wherein the sales objective is indicative of a goal of increasing sales revenue of the enterprise and the service objective is indicative of a motive of improving interaction experience of the customer.

33. The method of claim 29, further comprising:
predicting, by the processor, a propensity of the customer to perform at least one action based on the current activity of the customer during an ongoing interaction on the interaction channel associated with the enterprise, wherein the one or more recommendations are generated based on the predicted propensity of the customer and the corrected CLV estimate.

34. The method of claim 33, wherein an action from among the at least one action corresponds to one of purchasing one or more products of the enterprise, availing a service offered by the enterprise, interacting with an agent over the one or more interaction channels, and socializing at least one of a product, a purchase, a good sentiment, a bad sentiment, a brand, an experience and a feeling.

35. The method of claim 29, further comprising:
refining, by the processor, the corrected CLV estimate for the customer based on an experience of the customer during one or more previous interactions with the enterprise.

36. A computer-implemented method, comprising:
determining, by a processor, an estimate of a customer value for a customer of an enterprise based on a current activity of the customer on at least one interaction channel from among a plurality of interaction channels associated with the enterprise;
identifying, by the processor, a target treatment for the customer using interaction data associated with past interactions of the customer with the enterprise on one or more interaction channels from among the plurality of interaction channels, wherein the target treatment is identified upon determining the estimate of the customer value to be greater than a pre-determined threshold value; and
facilitating, by the processor, a provisioning of at least one of a personalized treatment and a preferential treatment to the customer during the current activity of the customer on the at least one interaction channel based on the identified target treatment.

37. The method of claim 36, wherein the estimate of the customer value is determined based on value of products viewed or enquired by the customer during the current activity of the customer on the at least one interaction channel.

38. The method of claim 36, further comprising:
identifying, by the processor, at least one persona type corresponding to the customer from among a plurality of persona types, each persona type from among the at least one persona type associated with a respective pre-determined correction factor, wherein the target treatment is identified based on the at least one persona type corresponding to the customer.

39. The method of claim 38, further comprising:
correcting, by the processor, the estimate of the customer value using the pre-determined correction factor corresponding to the each persona type to generate a corrected estimate of the customer value.
